(19) United States
(12) Patent Application Publication
(10) Pub. No.: US 2026/0319304 A1
(43) Pub. Date: Oct. 15, 2026

(54) Array Substrate and Display Apparatus

(71) Applicants: Beijing BOE Technology Development Co., Ltd., Beijing (CN); BOE Technology Group Co., Ltd., Beijing (CN)

(72) Inventors: Dongfang WANG, Beijing (CN); Hongda SUN, Beijing (CN); Yuhang LU, Beijing (CN); Fengjuan LIU, Beijing (CN); Lizhong WANG, Beijing (CN)

(21) Appl. No.: 18/880,578

(22) PCT Filed: Dec. 13, 2023
(86) PCT No.: PCT/CN2023/138522

§ 371 Date: Jan. 2, 2025

(51) Int. Cl. G02F 1/1368; G02F 1/1362

(52) U.S. Cl. CPC G02F 1/1368; G02F 1/136227; G02F 1/13624; G02F 1/136286

(57) ABSTRACT

An array substrate and a display apparatus are disclosed. The array substrate includes a base substrate (20). The base substrate (20) includes a display region (AA) and a non-display region (BB) surrounding the display region (AA). The display region (AA) includes at least one first transistor (21). The first transistor (21) includes a first active part (17), a first conductive part (16) and a second conductive part (18). The non-display region (BB) includes at least one second transistor (22). The second transistor (22) including a second active part (25), a third conductive part (26), and a fourth conductive part (24). The first active part (17) and the second active part (25) are both located in the semiconductor layer. The first conductive part (16) and the third conductive part (26) are located in different conductive layers.

### CROSS-REFERENCE TO RELATED APPLICATION

The present application is a U.S. National Phase Entry of International Application No. PCT/CN2023/138522 having an international filing date of Dec. 13, 2023, contents of which are incorporated into the present application by reference.

### TECHNICAL FIELD

The present disclosure relates to, but is not limited to, the field of display technologies, and in particular to an array substrate and a display apparatus.

### BACKGROUND

Liquid crystal display (LCD) is a common display type at present. The LCD display uses two pieces of polarized material, and a liquid crystal solution (liquid crystal) is located between the two pieces of polarized material. When the voltage is applied to two pieces of polarized material, the liquid crystal will deflect. By controlling the magnitude of the applied voltage, the degree of liquid crystal deflection can be adjusted. At present, liquid crystal displays (LCDs) are developing towards the goal of light, thin, short and small.

### SUMMARY

The following is a summary of subject matters described herein in detail. This summary is not intended to limit the protection scope of claims.

Embodiments of the present provide an array substrate and a display apparatus.

In one aspect, an embodiment of the present disclosure provides an array substrate. The array substrate includes a base substrate. The base substrate includes a display region and a non-display region surrounding the display region. The display region includes at least one first transistor. The first transistor includes a first active part, a first conductive part and a second conductive part. The non-display region includes at least one second transistor. The second transistor includes a second active part, a third conductive part and a fourth conductive part. Both the first active part and the second active part are located in a semiconductor layer. The first conductive part and the third conductive part are located in different conductive layers.

In a plane perpendicular to the array substrate, the second conductive part and the fourth conductive part are respectively located on both opposite sides of the semiconductor layer. The second conductive part is in a floating state.

In an exemplary embodiment, the non-display region includes a gate drive circuit. The gate drive circuit is configured to be electrically connected to a gate line of the display region, and the gate drive circuit includes the at least one second transistor.

In an exemplary embodiment, the non-display region includes at least one of an electrostatic discharge circuit, a test circuit, and a demultiplexer circuit. The electrostatic discharge circuit, the test circuit, and the demultiplexer circuit all include the at least one second transistor.

In an exemplary embodiment, the first conductive part is a gate of the first transistor. The second conductive part and the first conductive part are respectively located on both opposite sides of the first active part, and an orthographic projection of the second conductive part on a plane where the base substrate is located at least partially overlaps with an orthographic projection of the first active part on the plane where the base substrate is located.

The third conductive part is a gate of the second transistor. The fourth conductive part and the third conductive part are respectively located on both opposite sides of the second active part, and an orthographic projection of the fourth conductive part on the plane where the base substrate is located at least partially overlaps with an orthographic projection of the second active part on the plane where the base substrate is located.

Voltages applied by the second conductive part and the fourth conductive part are the same or different.

In an exemplary embodiment, the fourth conductive part is electrically connected to the first conductive part, and voltages applied by the fourth conductive part and the first conductive part are the same.

In an exemplary embodiment, a voltage of the second conductive part is lower than a voltage of the first conductive part.

In one aspect, an embodiment of the present disclosure provides an array substrate. The array substrate includes a base substrate. The base substrate includes a display region and a non-display region surrounding the display region. The display region includes at least one first transistor. The first transistor includes a first conductive part, a first active part, a second conductive part and a fifth conductive part. The second conductive part and the fifth conductive part are arranged on a same layer. The second conductive part is located on a side of the first conductive part away from the base substrate. The second conductive part is in a floating state.

In an exemplary embodiment, an absolute value of a difference between a value of a voltage applied by the second conductive part and a value of a voltage applied by the fifth conductive part is greater than an absolute value of a difference between the value of the voltage applied by the second conductive part and a value of a voltage applied by the first conductive part.

In an exemplary embodiment, the display region further includes at least one data line, the at least one data line being arranged on the same layer as the second conductive part.

In an exemplary embodiment, the at least one data line is electrically connected to the at least one first transistor via the fifth conductive part. An orthographic projection of the at least one data line on a plane where the base substrate is located includes an orthographic projection of the fifth conductive part on the plane where the base substrate is located.

In an exemplary embodiment, the display region further includes a gate insulating layer, and the gate insulating layer is located on a side of the first active part away from the base substrate. The gate insulating layer includes at least one first opening, and the fifth conductive part is located within the at least one first opening.

In an exemplary embodiment, an orthographic projection of the at least one data line on the plane where the base substrate is located at least partially overlaps with an orthographic projection of the at least one first opening on the plane where the base substrate is located.

In an exemplary embodiment, an orthographic projection of the at least one data line on the plane where the base substrate is located includes an orthographic projection of the at least one first opening on the plane where the base substrate is located.

In an exemplary embodiment, the at least one first opening exposes a part of a surface of the first active part away from the base substrate, and the fifth conductive part is in contact with a part of a surface of the first active part away from the base substrate.

In an exemplary embodiment, the display region further includes at least one common electrode and at least one pixel electrode, and both the at least one common electrode and the at least one pixel electrode are located on a side of the gate insulating layer away from the base substrate. An orthographic projection of the at least one common electrode on the plane where the base substrate is located at least partially overlaps with an orthographic projection of the at least one pixel electrode on the plane where the base substrate is located.

The gate insulating layer further includes at least one second opening, and the at least one pixel electrode is electrically connected to the at least one first transistor via the at least one second opening.

In an exemplary embodiment, the display region further includes at least one gate line, and the at least one gate line is arranged on the same layer as the first conductive part. The first active part includes a first section, a second section and a third section which are connected with each other. A first end of the first section is connected to a first end of the second section, and a second end of the first section extends in a second direction. A second end of the second section extends in a first direction, and a first end of the third section is connected to the second end of the second section, and a second end of the third section extends in the second direction. The first direction intersects the second direction.

An orthographic projection of the at least one first opening on the plane where the base substrate is located is within an orthographic projection of the first section on the plane where the base substrate is located. An orthographic projection of the at least one second opening on the plane where the base substrate is located is within an orthographic projection of the third section on the plane where the base substrate is located, and the at least one first opening and the at least one second opening are located on the same side of the gate line.

In an exemplary embodiment, the display region further includes at least one gate line, and the at least one gate line is arranged on the same layer as the first conductive part. The first active part includes a first section and a second section which are connected with each other. The first section extends in a first direction. A first end of the second section is connected to an end of the first section, and a second end of the second section extends in a second direction. The first direction intersects the second direction.

An orthogonal projection of the at least one first opening on the plane where the base substrate is located is within an orthogonal projection of the first section on the plane where the base substrate is located. An orthogonal projection of the at least one second opening on the plane where the base substrate is located is within an orthogonal projection of the second section on the plane where the base substrate is located, and the at least one first opening and the at least one second opening are located on both sides of the gate line.

In an exemplary embodiment, the display region further includes at least one gate line, and the at least one gate line is arranged on the same layer as the first conductive part. The first active part includes a first section and a second section which are connected with each other. The first section extends in a first direction. A first end of the second section is connected to an end of the first section, and a second end of the second section extends in a third direction. The first direction is perpendicular to a second direction, and the third direction is different from both the first direction and the second direction.

An orthogonal projection of the at least one first opening on the plane where the base substrate is located is within an orthogonal projection of the first section on the plane where the base substrate is located. An orthogonal projection of the at least one second opening on the plane where the base substrate is located is within an orthogonal projection of the second section on the plane where the base substrate is located, and the at least one first opening and the at least one second opening are located on both sides of the gate line.

In an exemplary embodiment, the display region further includes at least one gate line, and the at least one gate line is arranged on the same layer as the first conductive part. The first active part includes a first section, a second section and a third section which are connected with each other. A first end of the first section is connected to a first end of the second section. A second end of the first section extends in an opposite direction of a first direction. A second end of the second section extends in a third direction. The first direction is perpendicular to a second direction, and the third direction is different from both the first direction and the second direction. A first end of the third section is connected to the second end of the second section, and a second end of the third section extends in the second direction.

An orthographic projection of the at least one first opening on the plane where the base substrate is located is within an orthographic projection of the first section on the plane where the base substrate is located. An orthographic projection of the at least one second opening in the plane where the base substrate is located is within an orthographic projection of the third section in the plane where the base substrate is located, and the at least one first opening and the at least one second opening are located on both sides of the gate line.

In another aspect, an embodiment of the present disclosure provides a display apparatus. The display apparatus includes the array substrate according to any of the above embodiments, an opposing substrate, and a liquid crystal layer. The array substrate is arranged opposite to the opposing substrate, and the liquid crystal layer is located between the array substrate and the opposing substrate.

Other aspects of the present disclosure may be comprehended after the drawings and the detailed description are read and understood.

### BRIEF DESCRIPTION OF DRAWINGS

Accompanying drawings are intended to provide further understanding of technical solutions of the present disclosure and form a part of the specification, and are used to explain the technical solutions of the present disclosure together with embodiments of the present disclosure, but do not form limitations on the technical solutions of the present disclosure. Shapes and sizes of one or more components in the drawings do not reflect actual scales, and are only intended to schematically describe contents of the present disclosure.

FIG. 1A is a schematic front view of an array substrate according to an embodiment of the present disclosure.

FIG. 1B is a schematic partial cross-sectional view of an array substrate according to an embodiment of the present disclosure.

FIG. 2 is a schematic partial top view of a display region of an array substrate according to an embodiment of the present disclosure.

FIG. 2A is schematic partial cross-sectional view of a display region of an array substrate according to an embodiment of the present disclosure.

FIG. 3A is a first schematic partial top view of a display region of an array substrate according to an embodiment of the present disclosure.

FIG. 3B is a second schematic partial top view of a display region of an array substrate according to an embodiment of the present disclosure.

FIG. 3C is a third schematic partial top view of a display region of an array substrate according to an embodiment of the present disclosure.

FIG. 3D is a fourth schematic partial top view of a display region of an array substrate according to an embodiment of the present disclosure.

FIG. 4 is a schematic partial top view of a display region of an array substrate according to another embodiment of the present disclosure.

FIG. 4A is schematic partial cross-sectional view of a display region of an array substrate according to another embodiment of the present disclosure.

FIG. 5A is a first schematic partial top view of a display region of an array substrate according to another embodiment of the present disclosure.

FIG. 5B is a second schematic partial top view of a display region of an array substrate according to another embodiment of the present disclosure.

FIG. 5C is a third schematic partial top view of a display region of an array substrate according to another embodiment of the present disclosure.

FIG. 5D is a fourth schematic partial top view of a display region of an array substrate according to another embodiment of the present disclosure.

FIG. 6 is a schematic partial top view of a display region of an array substrate according to yet another embodiment of the present disclosure.

FIG. 6A is a schematic partial cross-sectional view of a display region of an array substrate according to yet another embodiment of the present disclosure.

FIG. 7A is a first schematic partial top view of a display region of an array substrate according to yet another embodiment of the present disclosure.

FIG. 7B is a second schematic partial top view of a display region of an array substrate according to yet another embodiment of the present disclosure.

FIG. 7C is a third schematic partial top view of a display region of an array substrate according to yet another embodiment of the present disclosure.

FIG. 7D is a fourth schematic partial top view of a display region of an array substrate according to yet another embodiment of the present disclosure.

FIG. 8 is a schematic partial top view of a display region of an array substrate according to yet another embodiment of the present disclosure.

FIG. 8A is a schematic partial cross-sectional view of a display region of an array substrate according to yet another embodiment of the present disclosure.

FIG. 9A is a first schematic partial top view of a display region of an array substrate according to yet another embodiment of the present disclosure.

FIG. 9B is a second schematic partial top view of a display region of an array substrate according to yet another embodiment of the present disclosure.

FIG. 9C is a third schematic partial top view of a display region of an array substrate according to yet another embodiment of the present disclosure.

FIG. 9D is a fourth schematic partial top view of a display region of an array substrate according to yet another embodiment of the present disclosure.

FIG. 10 is a schematic partial top view of a display region of an array substrate according to an exemplary embodiment of the present disclosure.

FIG. 10A is a schematic partial cross-sectional view of a display region of an array substrate according to an exemplary embodiment of the present disclosure.

FIG. 11 is a schematic partial top view of a display region of an array substrate according to another exemplary embodiment of the present disclosure.

FIG. 11A is a schematic partial cross-sectional view of a display region of an array substrate according to another exemplary embodiment of the present disclosure.

FIG. 12 is a schematic partial top view of a display region of an array substrate according to yet another exemplary embodiment of the present disclosure.

FIG. 12A is a schematic partial cross-sectional view of a display region of an array substrate according to yet another exemplary embodiment of the present disclosure.

FIG. 13 is a schematic partial top view of a display region of an array substrate according to yet another exemplary embodiment of the present disclosure.

FIG. 13A is a schematic partial cross-sectional view of a display region of an array substrate according to yet another exemplary embodiment of the present disclosure.

FIG. 14 is a schematic partial top view of a non-display region of an array substrate according to an embodiment of the present disclosure.

FIG. 14A is a schematic partial cross-sectional view of a non-display region of an array substrate according to an embodiment of the present disclosure.

FIG. 15 is a schematic partial cross-sectional view of a non-display region of an array substrate according to another embodiment of the present disclosure.

FIGS. 16A to 16H are schematic diagrams of a preparation process of a display region of an array substrate according to an embodiment of the present disclosure.

FIGS. 17A to 17C are schematic diagrams of a preparation process of a display region of an array substrate according to another embodiment of the present disclosure.

FIGS. 18A to 18C are schematic diagrams of a preparation process of a display region of an array substrate according to another embodiment of the present disclosure.

FIGS. 19A to 19C are schematic diagrams of a preparation process of a display region of an array substrate according to yet another embodiment of the present disclosure.

FIG. 20 is a schematic cross-sectional view of a display apparatus according to an embodiment of the present disclosure.

FIG. 21 is a characteristic test simulation graph of the first transistor.

### REFERENCE NUMBERS

AA—Display region, BB—Non-display region, B1—First bezel region, B2—Second bezel region;
10—Pixel electrode, 21—First transistor, 22—Second transistor, DL—Data line, GL—Gate line, 20—Base substrate, 11—First insulating layer, 12—Second insulating layer, 12-1—Initial pattern of a second insulating layer, 13—Third insulating layer, 14—Fourth insulating layer, 15—Fifth insulating layer, 16—First conductive part, 17—First active part, 17-1—First zone, 17-2—Second zone, 17-3—First channel zone, 171—First section, 172—Second section, 173—Third section, 18—Second conductive part, 19—Fifth conductive part, 23—Pixel connection electrode, 24—Fourth conductive part, 25—Second active part, 25-1—Second channel zone, 25-2—Third zone, 25-3—Four zone, 26—Third conductive part, 27—First connection electrode, 28—Second connection electrode, 29—Second gate, 30—Common electrode, 301—Hollow region, 1—Opposing substrate, 2—Liquid crystal layer, 3—Black matrix, 4—Color film layer, 5—Array substrate.

### DETAILED DESCRIPTION

The embodiments of the present disclosure will be described below with reference to the drawings in detail. Implementations may be implemented in a plurality of different forms. Those of ordinary skills in the art may easily understand such a fact that implementations and contents may be transformed into one or more forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the drawings, a size of one or more constituent elements, a thickness of a layer, or a region is sometimes exaggerated for clarity. Therefore, one implementation of the present disclosure is not necessarily limited to the size, and a shape and a size of one or more components in the drawings do not reflect an actual scale. In addition, the drawings schematically illustrate ideal examples, and an implementation of the present disclosure is not limited to shapes, numerical values, or the like shown in the drawings.

Ordinal numerals such as “first”, “second” and “third” in the present disclosure are set to avoid confusion between constituent elements, but not intended for restriction in quantity. In the present disclosure, “a plurality of/multiple” means two or more than two.

In the present disclosure, for convenience, wordings indicating orientation or positional relationship such as “middle”, “upper”, “lower”, “front”, “rear”, “vertical”, “horizontal”, “top”, “bottom”, “inner” and “outer” are employed to explain positional relationship between the constituent elements with reference to the drawings, they are employed for ease of description of the specification and simplification of the description only, but do not indicate or imply that the referred device or element must have a particular orientation, or is constructed and operate in a particular orientation, and therefore cannot be construed as limitations on the present disclosure. The positional relationships between the constituent elements are changed as appropriate based on directions according to which the constituent elements are described. Therefore, appropriate replacements based on situations are allowed, and the positional relationships are not limited to the expressions described in the specification.

In the present disclosure, the terms “mounted”, “connected” and “connection” are to be understood broadly, unless otherwise expressly specified and defined. For example, a connection may be a fixed connection, or a detachable connection, or an integral connection; it may be a mechanical connection or an electrical connection; it may be a direct connection, or an indirect connection through a middleware, or an internal communication between two elements. Those of ordinary skills in the art may understand meanings of the aforementioned terms in the present disclosure according to situations.

In the present disclosure, “electric connection” includes a case where constituent elements are connected through an element with a certain electrical action. An “element with a certain electrical action” is not particularly limited as long as electrical signals may be transmitted between the connected constituent elements. Examples of the “element with a certain electrical action” not only include electrodes and wirings, but also include switching elements such as transistors, resistors, inductors, capacitors, other elements with one or more functions, etc.

In the present disclosure, a transistor refers to an element including at least three terminals, i.e., a gate electrode, a drain electrode, and a source electrode. The transistor has a channel zone between the drain electrode (drain electrode terminal, drain area, or drain) and the source electrode (source electrode terminal, source area, or source), and a current can flow through the drain electrode, the channel zone and the source electrode. In the present disclosure, the channel zone refers to a region through which a current mainly flows.

In the present disclosure, a first electrode may be a drain electrode and a second electrode may be a source electrode, or a first electrode may be a source electrode and a second electrode may be a drain electrode. In a case that transistors with opposite polarities are used, or in a case that a direction of a current changes during operation of a circuit, or the like, functions of the “source electrode” and the “drain electrode” are sometimes interchangeable. Therefore, the “source electrode” and the “drain electrode” are interchangeable in the present disclosure.

In the present disclosure, “parallel” refers to a state in which an angle formed by two straight lines is above −10° and below 10°, and thus may include a state in which the angle is above −5° and below 5°. In addition, “perpendicular” refers to a state in which an angle formed by two straight lines is above 80° and below 100°, and thus may include a state in which the angle is above 85° and below 95°.

In the present disclosure, “film” and “layer” are interchangeable. For example, a “conductive layer” may be replaced with a “conductive film” sometimes. Similarly, an “insulating film” may be replaced with an “insulating layer” sometimes.

In the present disclosure, “about” or “approximately” refers to that a boundary is defined not so strictly and numerical values within process and measurement error ranges are allowed.

Triangle, rectangle, trapezoid, pentagon, hexagon or the like in the present disclosure are not strictly defined, and they may be approximate triangle, rectangle, trapezoid, pentagon, hexagon, etc. There may be some small deformations caused by tolerance, and there may be chamfer, arc edge, deformation, etc.

An embodiment of the present disclosure provides an array substrate. The array substrate includes a base substrate. The base substrate includes a display region and a non-display region surrounding the display region. The display region includes at least one first transistor. The first transistor includes a first active part, a first conductive part and a second conductive part. The non-display region includes at least one second transistor. The second transistor includes a second active part, a third conductive part and a fourth conductive part. Both the first active part and the second active part are located in a semiconductor layer. The first conductive part and the third conductive part are located in different conductive layers.

In a plane perpendicular to the array substrate, the second conductive part and the fourth conductive part are respectively located on both opposite sides of the semiconductor layer. The second conductive part is in a floating state.

The array substrate provided by the embodiment of the present disclosure optimizes a position relationship of the first conductive part, the second conductive part, the third conductive part, and the fourth conductive part relative to the semiconductor layer by arranging a structure of the first transistor and the second transistor. This is beneficial to adjusting the first transistor to a forward threshold voltage, and is beneficial to improving a sand phenomenon in the display region.

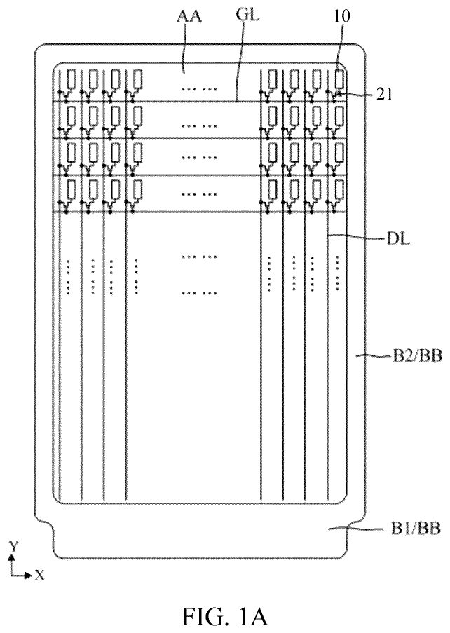

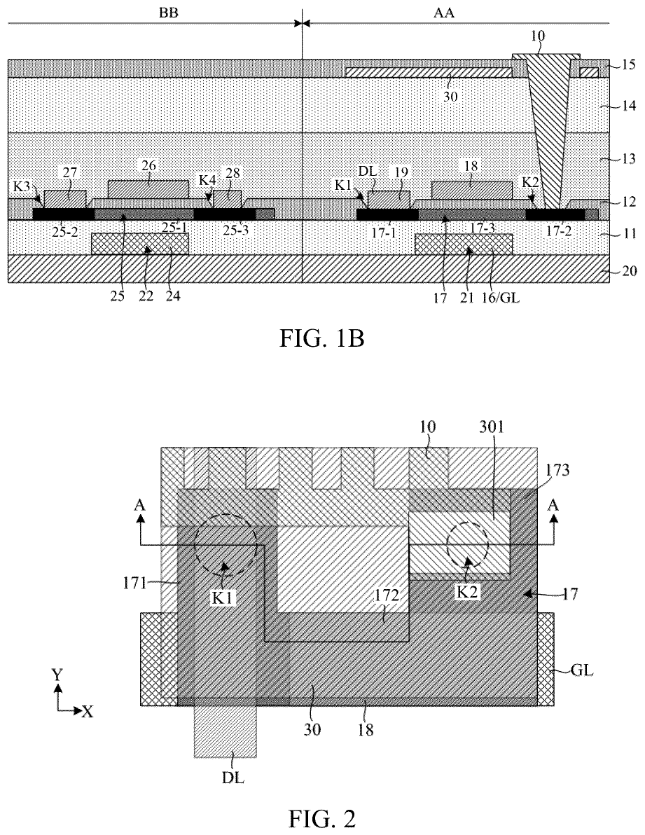

FIG. 1A is a schematic front view of an array substrate according to an embodiment of the present disclosure. As shown in FIG. 1A, the array substrate may include a display region AA and a non-display region BB located around the display region AA. The non-display region BB may include a first bezel region B1 located on a side of the display region AA and a second bezel region B2 located on remaining sides of the display region AA. For example, the first bezel region B1 may include a lower bezel of the array substrate, and the second bezel region B2 may include an upper bezel, a left bezel, and a right bezel of the array substrate.

In an exemplary embodiment, as shown in FIG. 1A, the display region AA may include a plurality of data lines DL and a plurality of gate lines GL disposed on a base substrate. The plurality of gate lines GL may extend along a first direction X, and are sequentially arranged along a second direction Y different from the first direction X. The plurality of data lines DL may extend along the second direction Y, and are sequentially arranged along the first direction X. The first direction X may intersect the second direction Y. For example, the first direction X may be perpendicular to the second direction Y. The plurality of data lines DL and the plurality of gate lines GL may be located in different film layers. For example, the plurality of data lines DL may be located on a side of the plurality of gate lines GL away from the base substrate.

In an exemplary embodiment, as shown in FIG. 1A, the plurality of data lines DL and the plurality of gate lines GL may intersect to form a plurality of sub-pixel regions. A region defined by adjacent data lines DL intersecting with adjacent gate lines GL may be a sub-pixel region. One sub-pixel may be correspondingly disposed in a sub-pixel region. The sub-pixel region may include an opening region and a non-opening region surrounding the opening region. The non-opening region may be a region that is shielded by a black matrix of an opposing substrate of the array substrate, and the opening region may be a region that is not shielded by the black matrix of the opposing substrate. The adjacent gate lines GL and the adjacent data lines DL may be all located in the non-opening region. The array substrate of the embodiment of the present disclosure may be configured to implement a display function, and the opening region of each sub-pixel region may be configured for display. The non-opening region surrounds the opening region, and does not perform displaying. However, the embodiments of the present disclosure are not limited to this. In some examples, the array substrate may be used for implementing other functions.

In an exemplary embodiment, the display region AA may include a plurality of pixel units disposed on the base substrate. At least one of the pixel units may include three sub-pixels (e.g. a first sub-pixel, a second sub-pixel, and a third sub-pixel arranged in sequence along the first direction X). The three sub-pixels of the pixel unit may be, for example, a blue sub-pixel, a red sub-pixel, and a green sub-pixel, and the three sub-pixels may be arranged sequentially in an order of the blue sub-pixel, the red sub-pixel, and the green sub-pixel. As shown in FIG. 1A, at least one sub-pixel may include a pixel electrode 10 and a common electrode (not shown in FIG. 1A), and orthographic projections of the pixel electrode 10 and the common electrode of the sub-pixel on the base substrate may overlap. Common electrodes of a plurality of sub-pixels in the display region AA may be of an integral structure. For example, the common electrode may be located on a side of the pixel electrode 10 close to the base substrate. The sub-pixel may further include a first transistor 21. The first transistor 21 may be close to a position where the data line DL and the gate line GL intersect. The first transistor 21 may include a first gate, a first electrode, and a second electrode. The first gate may be electrically connected to the gate line GL, the first electrode of the first transistor 21 may be electrically connected to the data line DL, and the second electrode may be electrically connected to the pixel electrode 10 of a sub-pixel. The first transistor 21 may be configured to supply a data signal transmitted by the data line DL to the pixel electrode 10 of the sub-pixel under control of the gate line GL.

In an exemplary embodiment, the second bezel region B2 may include at least a gate drive circuit (e.g., including a plurality of cascaded shift registers), and the plurality of shift registers may be electrically connected to a plurality of gate lines GL in the display region AA. The gate drive circuit may also include a second transistor. The second transistor may include a second gate, a third electrode, and a fourth electrode. In the present disclosure, the third electrode may be a drain electrode and the fourth electrode may be a source electrode, or the third electrode may be a source electrode and the fourth electrode may be a drain electrode.

In an exemplary embodiment, the non-display region BB may also include at least one of an electrostatic discharge circuit, a test circuit, and a demultiplexer circuit. The electrostatic discharge circuit, the test circuit, and the demultiplexer circuit may all include at least one second transistor. A demultiplexer is a device that recovers the composite signals in the multiplexed signals and restores these signals in their respective independent channels. The electrostatic discharge circuit may be configured to prevent electrostatic damage to the array substrate by eliminating static electricity.

A liquid crystal display apparatus has a plurality of display modes, such as ADS (Advanced Super Dimension Switch) mode, TN (Twisted Nematic) mode, VA (Vertical Alignment) mode, and the like. In the ADS mode, both the pixel electrode and the common electrode are located on the array substrate. In the TN mode and the VA mode, the pixel electrode and the common electrode are respectively disposed on two opposite sides of a liquid crystal layer, that is, the pixel electrode is located on the array substrate, and the common electrode is located on the opposing substrate.

The working principle of the ADS mode is that liquid crystal molecules are in a plane parallel to a glass substrate. When there is no voltage, light passes through a lower polarizing plate and then forms linearly polarized light parallel to a short axis of liquid crystal molecules. Since a direction of the polarized light cannot be rotated, it is absorbed by an upper polarizing plate and cannot be emitted. After applying a voltage, a transverse electric field is formed on the left and right sides of the liquid crystal, and the liquid crystal molecules are arranged in a direction of the electric field. After passing through the lower polarizing plate and the liquid crystal layer, the light is in an elliptically polarized state and may be emitted through the upper polarizing plate.

The working principle of TN mode is that in a voltage-free state, the liquid crystal molecules are twisted and aligned at 90° under the action of an alignment film, and light passes through the lower polarizing plate and the liquid crystal molecules and then is emitted from the upper polarizing plate. When a voltage is applied, most of the liquid crystal molecules are arranged vertically except the liquid crystal near matching films on upper and lower sides, and the light passing through the lower polarizing plate passes through the liquid crystal layer without deflection. Since it is parallel to a polarizing axis of the upper polarizing plate, the light is absorbed and cannot be emitted.

The working principle of VA mode is that liquid crystal molecules are aligned perpendicular to the glass substrate. When there is no voltage, light passes through the lower polarizing plate and then forms linearly polarized light parallel to a short axis of the liquid crystal molecules. Since a direction of the polarized light cannot be rotated, it is absorbed by the upper polarizing plate and cannot be emitted. After a voltage is applied, the liquid crystal molecules deflect along a direction of an electric field, and the light is in an elliptically polarized state after passing through the lower polarizing plate and the liquid crystal layer, and may be emitted through the upper polarizing plate.

A structure of an array substrate is introduced below by taking the ADS mode array substrate structure as an example.

FIG. 1B is a schematic partial cross-sectional view of an array substrate according to an embodiment of the present disclosure. As shown in FIG. 1B, the array substrate may include a base substrate 20, and a first conductive layer, a semiconductor layer, a second conductive layer, a third conductive layer and a fourth conductive layer disposed on a side of the base substrate 20. The array substrate may also include a first insulating layer 11 located between the first conductive layer and the semiconductor layer, a second insulating layer 12 located between the semiconductor layer and the second conductive layer, a third insulating layer 13 and a fourth insulating layer 14 located between the second conductive layer and the third conductive layer, and a fifth insulating layer 15 located between the third conductive layer and the fourth conductive layer.

As shown in FIG. 1B, the first conductive layer may include a first conductive part 16 of the first transistor 21 and a gate line GL, the first conductive part 16 being the first gate of the first transistor. The semiconductor layer may include a first active part 17 of a first transistor 21. The second conductive layer may include a data line DL, a fifth conductive part 19, and a second conductive part 18, the data line DL being electrically connected to a first electrode of the first transistor 21 via the fifth conductive part 19.

As shown in FIG. 1B, the first conductive layer may also include a fourth conductive part 24 of a second transistor 22. The semiconductor layer may also include a second active part 25 of the second transistor 22. The second conductive layer may also include a third conductive part 26 of the second transistor 22. The third conductive part 26 may be a second gate of the second transistor. The fourth conductive part 24 may be a light shielding layer of the second transistor.

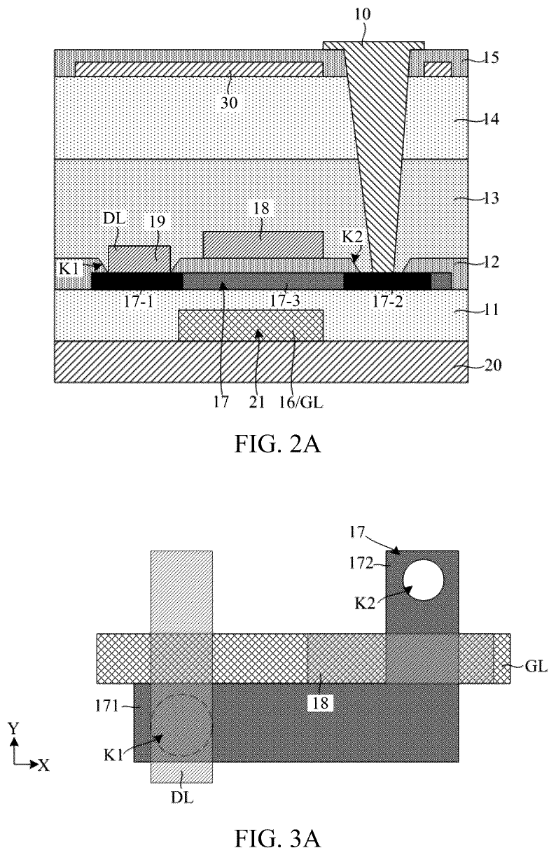

FIG. 2 is a schematic partial top view of a display region of an array substrate according to an embodiment of the present disclosure. FIG. 2A is a schematic partial cross-sectional view of a display region of an array substrate according to an embodiment of the present disclosure, and FIG. 2A is a schematic cross-sectional view at an identified A-A in FIG. 2. As shown in FIGS. 2 and 2A, the display region of the array substrate may include a base substrate 20 and a first conductive layer, a semiconductor layer, a second conductive layer, a third conductive layer, and a fourth conductive layer disposed on a side of the base substrate 20. The display region of the array substrate may also include a first insulating layer 11 located between the first conductive layer and the semiconductor layer, a second insulating layer 12 located between the semiconductor layer and the second conductive layer, a third insulating layer 13 and a fourth insulating layer 14 located between the second conductive layer and the third conductive layer, and a fifth insulating layer 15 located between the third conductive layer and the fourth conductive layer. In an embodiment of the present disclosure, the first insulating layer may also be referred to as a Buffer layer, the second insulating layer may also be referred to as a gate insulating (GI) layer, the third insulating layer may also be referred to as a first passivation (PVX1) layer, the fourth insulating layer may also be referred to as an organic insulating layer, and the fifth insulating layer may also be referred to as a second passivation (PVX2) layer.

The first conductive layer may include a first conductive part 16 of the first transistor 21 and a gate line GL, the first conductive part 16 being a first gate of the first transistor. The semiconductor layer may include a first active part 17 of the first transistor 21. The second conductive layer may include a data line DL, a fifth conductive part 19, and a second conductive part 18. The data line DL is electrically connected to a first electrode of the first transistor 21 via the fifth conductive part 19. The fifth conductive part 19 and the data line DL may be interconnected to form an integral structure. The third conductive layer may include a common electrode 30. The fourth conductive layer may include a pixel electrode 10 electrically connected to a second electrode of the first transistor 21. The common electrode 30 has a hollow region 301 via which the pixel electrode 10 may be electrically connected to the second electrode of the first transistor 21. In an embodiment of the present disclosure, by arranging a data line DL on a side of the first transistor away from the base substrate 20, a size of a first opening K1 provided in the second insulating layer 12 can be reduced. The data line DL is electrically connected to the first electrode of the first transistor 21 via the first opening K1. The fifth conductive part 19 is located in the first opening K1, so that an area of an opening region of the array substrate can be increased, and an aperture ratio of the array substrate can be increased. Further, by arranging the data line DL on a side of the first transistor away from the base substrate 20, damage to the first transistor caused by an etching operation or the like during the etching of the first opening K1 can be avoided, a thickness of a first active part of the first transistor can be reduced, and a performance of the transistor can be improved.

As shown in FIG. 2, the data line DL and the second conductive part 18 can be arranged in a same layer structure, so that the preparation process of the array substrate can be simplified, the number of masks used can be reduced, and the production cost of the display substrate can be reduced. The second conductive part 18 can function as a light shielding layer and can improve the service performance of the first transistor. The second conductive part 18 is in a floating state, and the first conductive part 16 is closer to the base substrate than the second conductive part 18, which facilitates the adjustment of the first transistor to a forward threshold voltage, and facilitates the improvement of a sand phenomenon in the display region. In embodiments of the present disclosure, the floating state indicates that the second conductive part 18 is not electrically connected to any of the other components, or that the second conductive part 18 is electrically connected to the other components and the applied voltage is zero.

In an exemplary embodiment, a voltage of the second conductive part 18 is lower than a voltage of the first conductive part 16.

In an exemplary embodiment, an absolute value of a difference between a voltage value applied by the second conductive part 18 and a voltage value applied by the fifth conductive part 19 is greater than an absolute value of a difference between the voltage value applied by the second conductive part 18 and a voltage value applied by the first conductive part 16.

In an exemplary embodiment, a line width of the data line DL may be greater than or equal to 0.4 microns and less than or equal to 5.0 microns. For example, the line width of the data line DL may be 2.5 microns.

In an exemplary embodiment, the base substrate 20 may provide support for film layers in the array substrate other than the base substrate 20. Exemplarily, the base substrate 20 may be a transparent base substrate. For example, the base substrate 20 may be a rigid base substrate or a flexible base substrate. For example, a material of the rigid base substrate may include, but is not limited to, one or more of glass and quartz. A material of the flexible base substrate may include, but is not limited to, one or more of polyethylene terephthalate, ethylene terephthalate, polyether ether ketone, polystyrene, polycarbonate, polyarylate, polyarylester, polyimide, polyvinyl chloride, polyethylene, and textile fiber. However, the embodiments of the present disclosure are not limited to this.

In an exemplary embodiment, the first conductive layer, the second conductive layer, and the third conductive layer may be made of metallic material(s), such as any one or more of molybdenum (Mo), aluminum (Al), copper (Cu) and titanium (Ti). Alternatively, the first conductive layer, the second conductive layer, and the third conductive layer may be made of an alloy material of metallic materials such as molybdenum (Mo), aluminum (Al), copper (Cu), and titanium (Ti), for example, an aluminum-neodymium alloy (AlNd) or a molybdenum-niobium alloy (MoNb), molybdenum-nickel-titanium alloy (MoNiTi). The first conductive layer, the second conductive layer, and the third conductive layer may be a monolayer structure or a multilayer composite structure, such as Ti/Al/Ti or Mo/Nb/Cu or MoNiTi/Cu or MoNb/Cu/MoNiTi or MoNiTi/Cu/MoNiTi or the like.

In an exemplary embodiment, a material of the fourth conductive layer may be a transparent conductive oxide material, which may include indium tin oxide (ITO) or indium zinc oxide (IZO). For example, the fourth conductive layer may be a monolayer structure, or a multilayer composite structure, such as ITO/Al/ITO, or the like.

In an exemplary embodiment, as shown in FIG. 2A, an orthographic projection of the first insulating layer 11 on the array substrate may include an orthographic projection of the first conductive layer on the array substrate. The first insulating layer 11 may block the erosion of the gate line and the first conductive part 16 by water and oxygen, thereby improving the reliability of the array substrate in use.

In an exemplary embodiment, a material of a first insulating layer 11, a second insulating layer 12, a third insulating layer 13, and a fifth insulating layer 15 may be an inorganic material. An inorganic material is, for example, one or more of silicon oxide nitride (SiO)ₓN_{y}) or silicon nitride (SiN)ₓ) or silicon oxide (SiOₓ) or the like. The first insulating layer 11, the second insulating layer 12, the third insulating layer 13, and the fifth insulating layer 15 may be a single layer, a multilayer, or a composite layer.

In an exemplary embodiment, a material of a fourth insulating layer 14 may be an organic material. The organic material is, for example, any one or several of epoxy resins, phenolic resins, urea-formaldehyde resins, melamine-formaldehyde resins, furan resins, silicone resins, polyester resins, polyamide resins, acrylic resins, polyurethane, vinyl resins, hydrocarbon resins, polyether resins, and the like. The fourth insulating layer 14 may be a single layer or a multilayer or a composite layer. In an embodiment of the present disclosure, the provision of the organic insulating layer can reduce crosstalk of the first conductive part to the common electrode.

In an exemplary embodiment, as shown in FIG. 2A, an orthographic projection of the first active part 17 on the array substrate may at least partially overlap with an orthographic projection of the first conductive part 16 on the array substrate. The first active part 17 may include a first channel zone 17-3, and a first zone 17-1 and a second zone 17-2 located on two opposite sides of the first channel zone 17-3. For example, in the process of preparing the array substrate, a conductorization processing may be performed on portions of the first active part 17, so that the portions of the first active part 17 form the first zone 17-1 and the second zone 17-2, respectively. The first zone 17-1 of the first active part 17 may be used as a first electrode of the first transistor, and the second zone 17-2 of the first active part 17 may be used as a second electrode of the first transistor. A conductorization process of the semiconductor layer is not limited in embodiments of the present disclosure.

In an exemplary embodiment, the first active part 17 may include at least two sub-active layers. For example, the first active part 17 may include two layers of sub-active layers, or the first active part 17 may include three layers of sub-active layers or the like.

In an exemplary embodiment, a material of the first active part 17 may include a metal oxide semiconductor material. Materials of the plurality of sub-active layers may be the same or different. The metal oxide semiconductor material may include one or more metal oxide materials such as indium gallium zinc oxide material (IGZO), nitrogen zinc oxide (ZnON), indium zinc tin oxide (IZTO), indium gallium tin oxide (IGTO), indium gallium zinc tin oxide (IGZTO), indium gallium zinc Y oxide (IGZYO, Y denotes doped tin) or the like. However, the present disclosure is not limited to metal oxide semiconductor materials. A material of the first active part 17 may be Low Temperature Poly-Silicon (LTPS) or the like.

In an exemplary embodiment, as shown in FIG. 2A, the fifth conductive part 19 may be electrically connected to the data line DL and the first zone 17-1 via the first opening K1 located in the second insulating layer 12. The pixel electrode 10 may be electrically connected to the second zone 17-2 via the second opening K2 located in the second insulating layer 12. An orthographic projection of the fifth conductive part 19 on the array substrate may be within an orthographic projection of the first opening K1 on the array substrate. For example, the orthographic projection of the fifth conductive part 19 on the array substrate coincides with the orthographic projection of the first opening K1 on the array substrate. The fifth conductive part 19 and the data line DL may be interconnected to form an integral structure. An orthographic projection of the data line DL on the array substrate may include the orthographic projection of the fifth conductive part 19 on the array substrate, so that an occupation of the fifth conductive part 19 on an area of the opening region of the array substrate can be reduced, and the aperture ratio of the array substrate can be increased.

In an exemplary embodiment, the aperture of the first opening K1 ranges from 1.0 microns to 6.0 microns.

In an exemplary embodiment, the aperture of the second opening K2 ranges from 1.0 microns to 15.0 microns.

In an exemplary embodiment, at least a portion of an orthographic projection of the first opening K1 on the array substrate is located within an orthographic projection of the first active part 17 on the array substrate. For example, a portion of the orthographic projection of the first opening K1 on the array substrate is located within the orthographic projection of the first active part 17 on the array substrate, or all of the orthographic projection of the first opening K1 on the array substrate is located within the orthographic projection of the first active part 17 on the array substrate.

In an exemplary embodiment, at least a portion of an orthographic projection of the second opening K2 on the array substrate is located within the orthographic projection of the first active part 17 on the array substrate. For example, a portion of the orthographic projection of the second opening K2 on the array substrate is located within the orthographic projection of the first active part 17 on the array substrate, or all of the orthographic projection of the second opening K2 on the array substrate is located within the orthographic projection of the first active part 17 on the array substrate.

In an exemplary embodiment, as shown in FIG. 2, the gate line GL may be a line shape extending in the first direction X, and the data line DL may be a line shape extending in the second direction Y. In an embodiment of the present disclosure, a direction of the line width of the data line DL is parallel to the first direction X. An orthographic projection of the data line DL on the array substrate may include an orthographic projection of the first opening K1 on the array substrate.

As shown in FIG. 2, the first active part 17 may include a first section 171, a second section 172, and a third section 173 which are connected with each other. A first end of the first section 171 may be connected to a first end of the second section 172, and a second end of the first section 171 may extend in the second direction Y. A second end of the second section 172 may extend in a first direction X. A first end of the third section 173 may be connected to the second end of the second section 172, and a second end of the third section 173 may extend in a second direction Y. The first zone of the first active part 17 may be located in the first section 171. The first channel zone of the first active part 17 may be located in the second section 172, and the second zone of the first active part 17 may be located in the third section 173. The orthographic projection of the first opening K1 on the array substrate may be located in an orthographic projection of the first section 171 on the array substrate, the orthographic projection of the second opening K2 on the array substrate may be located in an orthographic projection of the third section 173 on the array substrate, and the first opening K1 and the second opening K2 are located on the same side in an extending direction of the gate line GL.

In an exemplary embodiment, as shown in FIG. 2, an orthographic projection of the second conductive part 18 on the array substrate may be a rectangle, and an orthographic projection of the second conductive part 18 on the array substrate may at least partially overlap with an orthographic projection of the second section 172 on the array substrate.

In some exemplary embodiments, the first opening K1 may be a circular opening, a rectangular opening, an elliptical opening, a hexagonal opening, or the like.

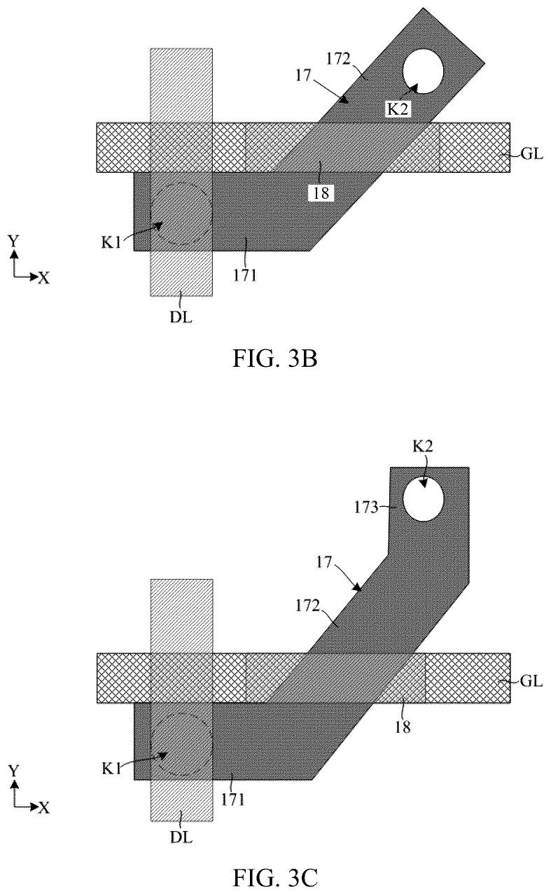

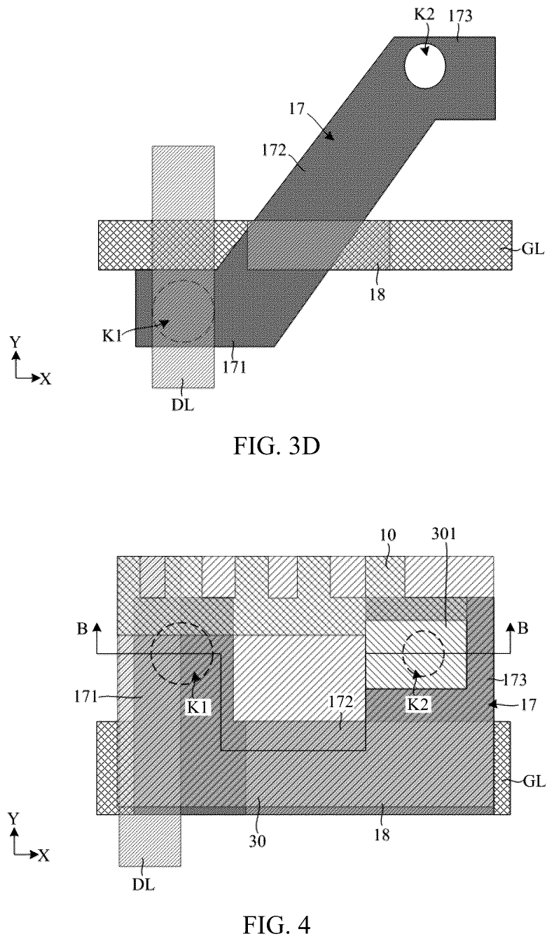

FIG. 3A is a first schematic partial top view of a display region of an array substrate according to an embodiment of the present disclosure. As shown in FIG. 3A, FIG. 3A is a schematic partial top view after a second conductive layer is formed in a display region of an array substrate. As shown in FIG. 3A, a gate line GL may be a line shape extending in a first direction X, and a data line DL may be a line shape extending in a second direction Y. An orthographic projection of the data line DL on the array substrate may include an orthographic projection of a first opening K1 on the array substrate.

As shown in FIG. 3A, a first active part 17 may include a first section 171 and a second section 172 which are connected with each other. The first section 171 extends in the first direction X. A first end of the second section 172 is connected to an end of the first section 171, and a second end of the second section 172 extends in the second direction Y. A first zone and a first channel zone of the first active part 17 may both be located in the first section 171, and a second zone of the first active part 17 may be located in the second section 172. An orthographic projection of a first opening K1 on the array substrate may be located in an orthographic projection of the first section 171 on the array substrate, an orthographic projection of a second opening K2 on the array substrate may be located in an orthographic projection of the second section 172 on the array substrate, and the first opening K1 and the second opening K2 are located on both sides of an extending direction of the gate line GL.

As shown in FIG. 3A, an orthographic projection of the second conductive part 18 on the array substrate may be a rectangle, and the orthographic projection of the second conductive part 18 on the array substrate may at least partially overlap with an orthographic projection of the first section 171 on the array substrate.

FIG. 3B is a second schematic partial top view of a display region of an array substrate according to an embodiment of the present disclosure. As shown in FIG. 3B, FIG. 3B is a schematic partial top view after a second conductive layer is formed in a display region of an array substrate. As shown in FIG. 3B, a gate line GL may be a line shape extending in a first direction X, and a data line DL may be a line shape extending in a second direction Y. An orthographic projection of the data line DL on the array substrate may include an orthographic projection of a first opening K1 on the array substrate.

As shown in FIG. 3B, a first active part 17 may include a first section 171 and a second section 172 which are connected with each other. The first section 171 extending in the first direction X. A first end of the second section 172 is connected to an end of the first section 171, and a second end of the second section 172 may extend in a direction different from the first direction X and the second direction Y, which may be referred to as a third direction. For example, the third direction may be a diagonal direction of the first direction X and the second direction Y, and the second end of the second section 172 may extend in the diagonal direction of the first direction X and the second direction Y. A first zone of the first active part 17 may be located in the first section 171, and a second zone of the first active part 17 may be located in the second section 172. A portion of a first channel zone of the first active part 17 may be located in the first section 171, and other portions of the first channel zone of the first active part 17 may be located in the second section 172. An orthographic projection of a first opening K1 on the array substrate may be located in an orthographic projection of the first section 171 on the array substrate, an orthographic projection of a second opening K2 on the array substrate may be located in an orthographic projection of the second section 172 on the array substrate, and the first opening K1 and the second opening K2 are located on both sides of an extending direction of the gate line GL.

As shown in FIG. 3B, an orthographic projection of the second conductive part 18 on the array substrate may be a rectangle, and an orthographic projection of the second conductive part 18 on the array substrate may at least partially overlap with orthographic projections of the first section 171 and the second section 172 on the array substrate.

FIG. 3C is a third schematic partial top view of a display region of an array substrate according to an embodiment of the present disclosure. As shown in FIG. 3C, FIG. 3C is a schematic partial top view after a second conductive layer is formed in the display region of the array substrate. As shown in FIG. 3C, a gate line GL may be a line shape extending in a first direction X, and a data line DL may be a line shape extending in a second direction Y. An orthographic projection of the data line DL on the array substrate may include an orthographic projection of a first opening K1 on the array substrate.

As shown in FIG. 3C, a first active part 17 may include a first section 171, a second section 172, and a third section 173 which are connected with each other. A first end of the first section 171 may be connected to a first end of the second section 172, and a second end of the first section 171 may extend in an opposite direction of the first direction X. A second end of the second section 172 may extend in a third direction different from the first direction X and the second direction Y. For example, the third direction may be a diagonal direction of the first direction X and the second direction Y. The second end of the second section 172 may extend in the diagonal direction of the first direction X and the second direction Y. A first end of the third section 173 may be connected to the second end of the second section 172, and a second end of the third section 173 may extend in the second direction Y. A first zone of the first active part 17 may be located in the first section 171. A portion of a first channel zone of the first active part 17 may be located in the first section 171, and other portions of the first channel zone of the first active part 17 may be located in the second section 172. A second zone of the first active part 17 may be located in the third section 173. An orthographic projection of the first opening K1 on the array substrate may be located in an orthographic projection of the first section 171 on the array substrate, an orthographic projection of a second opening K2 on the array substrate may be located in an orthographic projection of the third section 173 on the array substrate, and the first opening K1 and the second opening K2 are located on both sides of an extending direction of the gate line GL.

As shown in FIG. 3C, an orthographic projection of the second conductive part 18 on the array substrate may be a rectangle, and the orthographic projection of the second conductive part 18 on the array substrate may at least partially overlap with orthographic projections of the first section 171 and the second section 172 on the array substrate.

FIG. 3D is a fourth schematic partial top view of a display region of an array substrate according to an embodiment of the present disclosure. As shown in FIG. 3D, FIG. 3D is a schematic partial top view after a second conductive layer is formed in the display region of the array substrate. As shown in FIG. 3D, a gate line GL may be a line shape extending in a first direction X, and a data line DL may be a line shape extending in a second direction Y. An orthographic projection of the data line DL on the array substrate may include an orthographic projection of a first opening K1 on the array substrate.

As shown in FIG. 3D, a first active part 17 may include a first section 171, a second section 172, and a third section 173 which are connected with each other. A first end of the first section 171 may be connected to a first end of the second section 172, and a second end of the first section 171 may extend in an opposite direction of the first direction X. A second end of the second section 172 may extend in a third direction different from the first direction X and the second direction Y. For example, the second end of the second section 172 may extend in a diagonal direction of the first direction X and the second direction Y. A first end of the third section 173 may be connected to the second end of the second section 172, and a second end of the third section 173 may extend in the first direction X. A first zone of the first active part 17 may be located in the first section 171. A portion of a first channel zone of the first active part 17 may be located in the first section 171, and other portions of the first channel zone of the first active part 17 may be located in the second section 172. A second zone of the first active part 17 may be located in the third section 173. An orthographic projection of the first opening K1 on the array substrate may be located in an orthographic projection of the first section 171 on the array substrate, an orthographic projection of a second opening K2 on the array substrate may be located in an orthographic projection of the third section 173 on the array substrate, and the first opening K1 and the second opening K2 are located on both sides of an extending direction of the gate line GL.

As shown in FIG. 3D, an orthographic projection of the second conductive part 18 on the array substrate may be a rectangle, and the orthographic projection of the second conductive part 18 on the array substrate may at least partially overlap with orthographic projections of the first section 171 and the second section 172 on the array substrate.

An array substrate provided by an embodiment of the present disclosure can adapt to different structural layouts of the display apparatus by various variants of the shape of the first active part, which can improve the design flexibility of the array substrate, and improve the versatility of the array substrate.

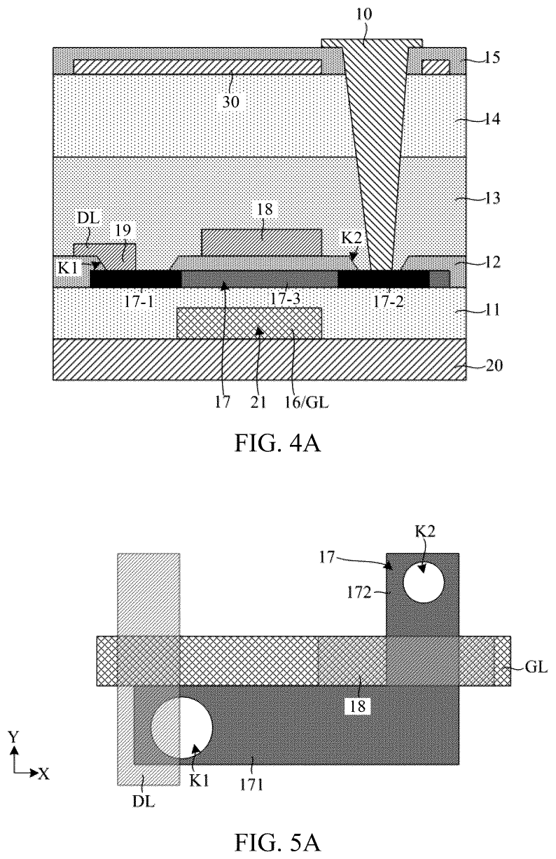

FIG. 4 is a schematic partial top view of a display region of an array substrate according to another embodiment of the present disclosure. FIG. 4A is a schematic partial cross-sectional view of a display region of an array substrate according to another embodiment of the present disclosure, and FIG. 4A is a schematic cross-sectional view at an identified B-B in FIG. 4. As shown in FIGS. 4 and 4A, the display region of the array substrate may include a base substrate 20 and a first conductive layer, a semiconductor layer, a second conductive layer, a third conductive layer, and a fourth conductive layer disposed on a side of the base substrate 20. The display region of the array substrate may also include a first insulating layer 11 located between the first conductive layer and the semiconductor layer, a second insulating layer 12 located between the semiconductor layer and the second conductive layer, a third insulating layer 13 and a fourth insulating layer 14 located between the second conductive layer and the third conductive layer, and a fifth insulating layer 15 located between the third conductive layer and the fourth conductive layer.

The first conductive layer may include a first conductive part 16 of the first transistor 21 and a gate line GL, and the first conductive part 16 may be a first gate of the first transistor. The semiconductor layer may include a first active part 17 of the first transistor 21. The second conductive layer may include a data line DL, a fifth conductive part 19, and a second conductive part 18. The data line DL is electrically connected to a first electrode of the first transistor 21 via the fifth conductive part 19. The fifth conductive part 19 and the data line DL may be interconnected to form an integral structure. The third conductive layer may include a common electrode 30. The fourth conductive layer may include a pixel electrode 10 electrically connected to a second electrode of the first transistor 21. The common electrode 30 has a hollow region 301 via which the pixel electrode 10 may be electrically connected to the second electrode of the first transistor 21. In an embodiment of the present disclosure, by arranging the data line DL on a side of the first transistor away from the base substrate 20, it is possible to reduce the size of the opening provided in the second insulating layer 12. The data line DL is electrically connected to the first electrode of the first transistor 21 via the opening, and the fifth conductive part 19 is located in the opening, so that an area of the opening area of the array substrate can be increased, and an aperture ratio of the array substrate can be increased. Further, by arranging the data line DL on a side of the first transistor away from the base substrate 20, damage to the first transistor caused by an etching operation or the like during the etching of a first opening K1 can be avoided, a thickness of the first active part of the first transistor can be reduced, and a performance of the transistor can be improved.

In an exemplary embodiment, as shown in FIG. 4A, the fifth conductive part 19 may be electrically connected to the data line DL and the first zone 17-1 via the first opening K1 located in the second insulating layer 12. The pixel electrode 10 may be electrically connected to the second zone 17-2 via a second opening K2 located in the second insulating layer 12. An orthographic projection of the fifth conductive part 19 on the array substrate is within an orthographic projection of the first opening K1 on the array substrate, and the orthographic projection of the fifth conductive part 19 on the array substrate is smaller than the orthographic projection of the first opening K1 on the array substrate. The fifth conductive part 19 and the data line DL may be interconnected to form an integral structure. An orthographic projection of the data line DL on the array substrate may include the orthographic projection of the fifth conductive part 19 on the array substrate, so that an occupation of the fifth conductive part 19 on an area of the opening region of the array substrate can be reduced, and the aperture ratio of the array substrate can be increased.

In an exemplary embodiment, as shown in FIG. 4A, an orthographic projection of the data line DL on the array substrate partially overlaps with an orthographic projection of the first opening K1 on the array substrate, and the size of the partial overlap in a direction of a line width of the data line DL is less than or equal to 1.5 microns.

In an exemplary embodiment, as shown in FIG. 4, the gate line GL may be a line shape extending in a first direction X, and the data line DL may be a line shape extending in a second direction Y. An orthographic projection of the data line DL on the array substrate partially overlaps with an orthographic projection of the first opening K1 on the array substrate.

As shown in FIG. 4, the first active part 17 may include a first section 171, a second section 172, and a third section 173 which are connected with each other. A first end of the first section 171 may be connected to a first end of the second section 172, and a second end of the first section 171 may extend in the second direction Y. A second end of the second section 172 may extend in the first direction X. A first end of the third section 173 may be connected to the second end of the second section 172, and a second end of the third section 173 may extend in the second direction Y. A first zone of the first active part 17 may be located in the first section 171. A first channel zone of the first active part 17 may be located in the second section 172, and a second zone of the first active part 17 may be located in the third section 173.

As shown in FIG. 4, an orthographic projection of the second conductive part 18 on the array substrate may be a rectangle. The orthographic projection of the second conductive part 18 on the array substrate may at least partially overlap with an orthographic projection of the second section 172 on the array substrate.

In some exemplary embodiments, the first opening K1 may be a circular opening, a rectangular opening, an elliptical opening, a hexagonal opening, or the like.

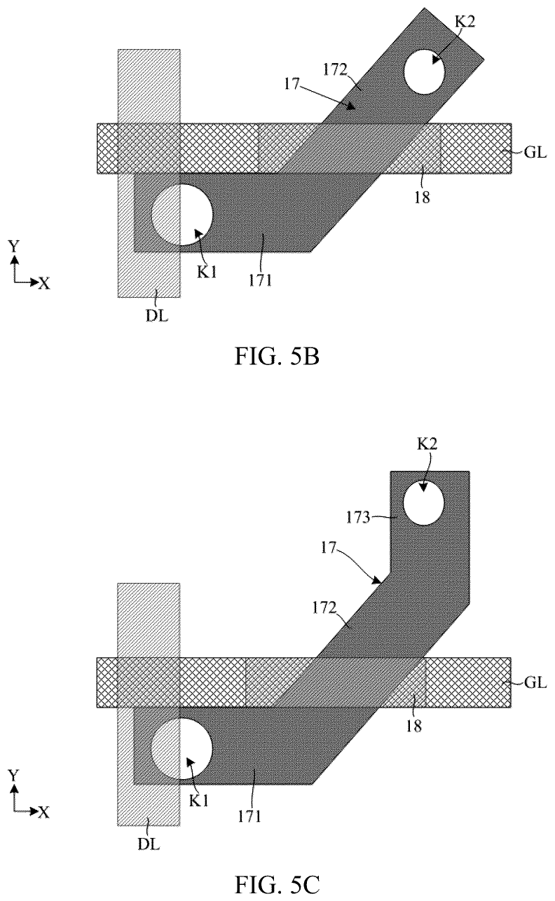

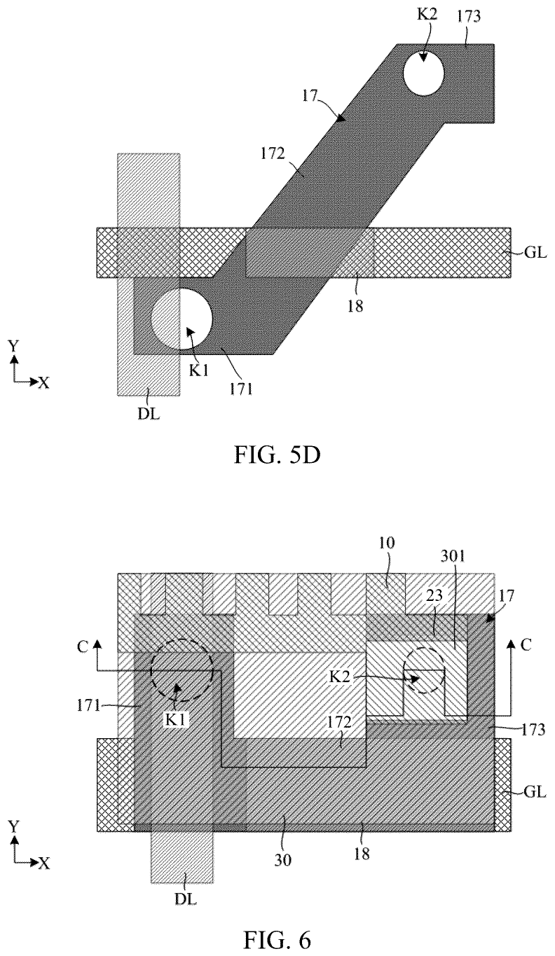

FIG. 5A is a first schematic partial top view of a display region of an array substrate according to another embodiment of the present disclosure. As shown in FIG. 5A, FIG. 5A is a schematic partial top view after a second conductive layer is formed in a display region of an array substrate. As shown in FIG. 5A, a gate line GL may be a line shape extending in a first direction X, and a data line DL may be a line shape extending in a second direction Y. An orthographic projection of the data line DL on the array substrate partially overlaps with an orthographic projection of a first opening K1 on the array substrate.

As shown in FIG. 5A, a first active part 17 may include a first section 171 and a second section 172 which are connected with each other. The first section 171 extends in the first direction X. A first end of the second section 172 is connected to an end of the first section 171, and a second end of the second section 172 extends in the second direction Y. A first zone and a first channel zone of the first active part 17 may both be located in the first section 171, and a second zone of the first active part 17 may be located in the second section 172.

As shown in FIG. 5A, an orthographic projection of the second conductive part 18 on the array substrate may be a rectangle, and the orthographic projection of the second conductive part 18 on the array substrate may at least partially overlap with the orthographic projection of the first section 171 on the array substrate.

FIG. 5B is a second schematic partial top view of a display region of an array substrate according to another embodiment of the present disclosure. As shown in FIG. 5B, FIG. 5B is a schematic partial top view after a second conductive layer is formed in a display region of an array substrate. As shown in FIG. 5B, a gate line GL may be a line shape extending in a first direction X, and a data line DL may be a line shape extending in a second direction Y. An orthographic projection of the data line DL on the array substrate partially overlaps with an orthographic projection of a first opening K1 on the array substrate.

As shown in FIG. 5B, a first active part 17 may include a first section 171 and a second section 172 which are connected with each other. The first section 171 extends in the first direction X. A first end of the second section 172 is connected to an end of the first section 171, and a second end of the second section 172 may extend in a direction different from the first direction X and the second direction Y. For example, the second end of the second section 172 may extend in a diagonal direction of the first direction X and the second direction Y. A first zone of the first active part 17 may be located in the first section 171, and a second zone of the first active part 17 may be located in the second section 172. A portion of a first channel zone of the first active part 17 may be located in the first section 171, and other portions of the first channel zone of the first active part 17 may be located in the second section 172.

As shown in FIG. 5B, an orthographic projection of the second conductive part 18 on the array substrate may be a rectangle, and the orthographic projection of the second conductive part 18 on the array substrate may at least partially overlap with orthographic projections of the first section 171 and the second section 172 on the array substrate.

FIG. 5C is a third schematic partial top view of a display region of an array substrate according to another embodiment of the present disclosure. As shown in FIG. 5C, FIG. 5C is a schematic partial top view after a second conductive layer is formed in the display region of the array substrate. As shown in FIG. 5C, a gate line GL may be a line shape extending in a first direction X, and a data line DL may be a line shape extending in a second direction Y. An orthographic projection of the data line DL on the array substrate partially overlaps with an orthographic projection of a first opening K1 on the array substrate.

As shown in FIG. 5C, a first active part 17 may include a first section 171, a second section 172, and a third section 173 which are connected with each other. A first end of the first section 171 may be connected to a first end of the second section 172, and a second end of the first section 171 may extend in an opposite direction of the first direction X. A second end of the second section 172 may extend in a direction different from the first direction X and the second direction Y. For example, the second end of the second section 172 may extend in a diagonal direction of the first direction X and the second direction Y. A first end of the third section 173 may be connected to the second end of the second section 172, and a second end of the third section 173 may extend in the second direction Y. A first zone of the first active part 17 may be located in the first section 171. A portion of a first channel zone of the first active part 17 may be located in the first section 171, and other portions of the first channel zone of the first active part 17 may be located in the second section 172. A second zone of the first active part 17 may be located in the third section 173.

As shown in FIG. 5C, an orthographic projection of the second conductive part 18 on the array substrate may be a rectangle, and the orthographic projection of the second conductive part 18 on the array substrate may at least partially overlap with orthographic projections of the first section 171 and the second section 172 on the array substrate.

FIG. 5D is a fourth schematic partial top view of a display region of an array substrate according to another embodiment of the present disclosure. As shown in FIG. 5D, FIG. 5D is a schematic partial top view after a second conductive layer is formed in the display region of the array substrate. As shown in FIG. 5D, a gate line GL may be a line shape extending in a first direction X, and a data line DL may be a line shape extending in a second direction Y. An orthographic projection of the data line DL on the array substrate partially overlaps with an orthographic projection of a first opening K1 on the array substrate.

As shown in FIG. 5D, a first active part 17 may include a first section 171, a second section 172, and a third section 173 which are connected with each other. A first end of the first section 171 may be connected to a first end of the second section 172, and a second end of the first section 171 may extend in an opposite direction of the first direction X. The second end of the second section 172 may extend in a direction different from the first direction X and the second direction Y. For example, the second end of the second section 172 may extend in a diagonal direction of the first direction X and the second direction Y. A first end of the third section 173 may be connected to the second end of the second section 172, and a second end of the third section 173 may extend in the first direction X. A first zone of the first active part 17 may be located in the first section 171. A portion of a first channel zone of the first active part 17 may be located in the first section 171, and other portions of the first channel zone of the first active part 17 may be located in the second section 172. A second zone of the first active part 17 may be located in the third section 173.

As shown in FIG. 5D, an orthographic projection of the second conductive part 18 on the array substrate may be a rectangle, and the orthographic projection of the second conductive part 18 on the array substrate may at least partially overlap with orthographic projections of the first section 171 and the second section 172 on the array substrate.

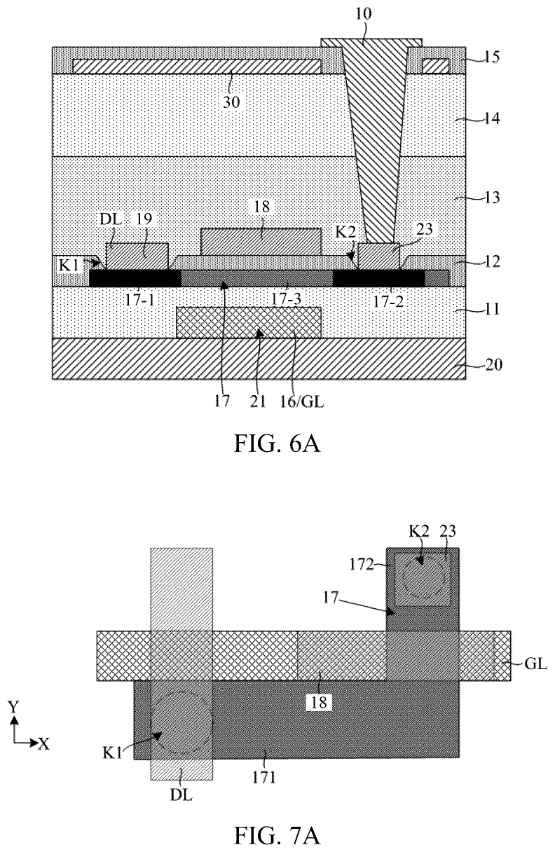

FIG. 6 is a schematic partial top view of a display region of an array substrate according to yet another embodiment of the present disclosure. FIG. 6A is a schematic partial cross-sectional view of a display region of an array substrate according to yet another embodiment of the present disclosure, and FIG. 6A is a schematic cross-sectional view at an identified C-C in FIG. 6. As shown in FIGS. 6 and 6A, the display region of the array substrate may include a base substrate 20 and a first conductive layer, a semiconductor layer, a second conductive layer, a third conductive layer, and a fourth conductive layer disposed on a side of the base substrate 20. The display region of the array substrate may also include a first insulating layer 11 located between the first conductive layer and the semiconductor layer, a second insulating layer 12 located between the semiconductor layer and the second conductive layer, a third insulating layer 13 and a fourth insulating layer 14 located between the second conductive layer and the third conductive layer, and a fifth insulating layer 15 located between the third conductive layer and the fourth conductive layer.

The first conductive layer may include a first conductive part 16 of the first transistor 21 and a gate line GL, and the first conductive part 16 may be a first gate of the first transistor. The semiconductor layer may include a first active part 17 of the first transistor 21. The second conductive layer may include a data line DL, a fifth conductive part 19, a second conductive part 18, and a pixel connection electrode 23. The data line DL is electrically connected to a first electrode of the first transistor 21 via the fifth conductive part 19. The fifth conductive part 19 and the data line DL may be interconnected to form an integral structure. The third conductive layer may include a common electrode 30, and the fourth conductive layer may include a pixel electrode 10 electrically connected to a second electrode of the first transistor 21 via a pixel connection electrode 23. The common electrode 30 has a hollow region 301 via which the pixel electrode 10 may be electrically connected to a second electrode of the first transistor 21. In an embodiment of the present disclosure, by arranging the data line DL on a side of the first transistor away from the base substrate 20, it is possible to reduce a size of an opening provided in the second insulating layer 12. The data line DL is electrically connected to the first electrode of the first transistor 21 via the opening, and the fifth conductive part 19 is located in the opening, so that an area of the opening area of the array substrate can be increased, and an aperture ratio of the array substrate can be increased.

In an exemplary embodiment, as shown in FIG. 6A, the fifth conductive part 19 may be electrically connected to the data line DL and a first zone 17-1 via a first opening K1 located in the second insulating layer 12. An orthographic projection of the fifth conductive part 19 on the array substrate may be within an orthographic projection of the first opening K1 on the array substrate. For example, the orthographic projection of the fifth conductive part 19 on the array substrate coincides with the orthographic projection of the first opening K1 on the array substrate. The fifth conductive part 19 and the data line DL may be interconnected to form an integral structure. An orthographic projection of the data line DL on the array substrate may include the orthographic projection of the fifth conductive part 19 on the array substrate, so that an occupation of the fifth conductive part 19 on an area of the opening region of the array substrate can be reduced, and the aperture ratio of the array substrate can be increased.

In an exemplary embodiment, as shown in FIG. 6A, the pixel connection electrode 23 may be electrically connected to the pixel electrode 10 and a second zone 17-2 via a second opening K2 located in the second insulating layer 12. An orthographic projection of the pixel connection electrode 23 on the array substrate may be located within an orthographic projection of the second opening K2 on the array substrate. For example, the orthographic projection of the pixel connection electrode 23 on the array substrate coincides with the orthographic projection of the second opening K2 on the array substrate. Providing the pixel connection electrode 23 can reduce a size of the pixel electrode 10 in a direction of a thickness of the array substrate and can improve the reliability of the electric connection of the pixel electrode.

In an exemplary embodiment, as shown in FIG. 6, the gate line GL may be a line shape extending in a first direction X, and the data line DL may be a line shape extending in a second direction Y. An orthographic projection of the data line DL on the array substrate may include an orthographic projection of the first opening K1 on the array substrate.

In an exemplary embodiment, as shown in FIG. 6, the first active part 17 may include a first section 171, a second section 172, and a third section 173 which are connected with each other. A first end of the first section 171 may be connected to a first end of the second section 172, and a second end of the first section 171 may extend in the second direction Y. A second end of the second section 172 may extend in the first direction X. A first end of the third section 173 may be connected to the second end of the second section 172, and a second end of the third section 173 may extend in the second direction Y. A first zone of the first active part 17 may be located in the first section 171. A first channel zone of the first active part 17 may be located in the second section 172, and a second zone of the first active part 17 may be located in the third section 173.

As shown in FIG. 6, an orthographic projection of the second conductive part 18 on the array substrate may be a rectangle. The orthographic projection of the second conductive part 18 on the array substrate may at least partially overlap with an orthographic projection of the second section 172 on the array substrate.

As shown in FIG. 6, an orthographic projection of the pixel connection electrode 23 on the array substrate may be a rectangle. The orthographic projection of the pixel connection electrode 23 on the array substrate may be located within an orthographic projection of the third section 173 on the array substrate, and the orthographic projection of the pixel connection electrode 23 on the array substrate may include an orthographic projection of the second opening K2 on the array substrate.

In some exemplary embodiments, the first opening K1 may be a circular opening, a rectangular opening, an elliptical opening, a hexagonal opening, or the like.

In some exemplary embodiments, the second opening K2 may be a circular opening, a rectangular opening, an elliptical opening, a hexagonal opening, or the like.

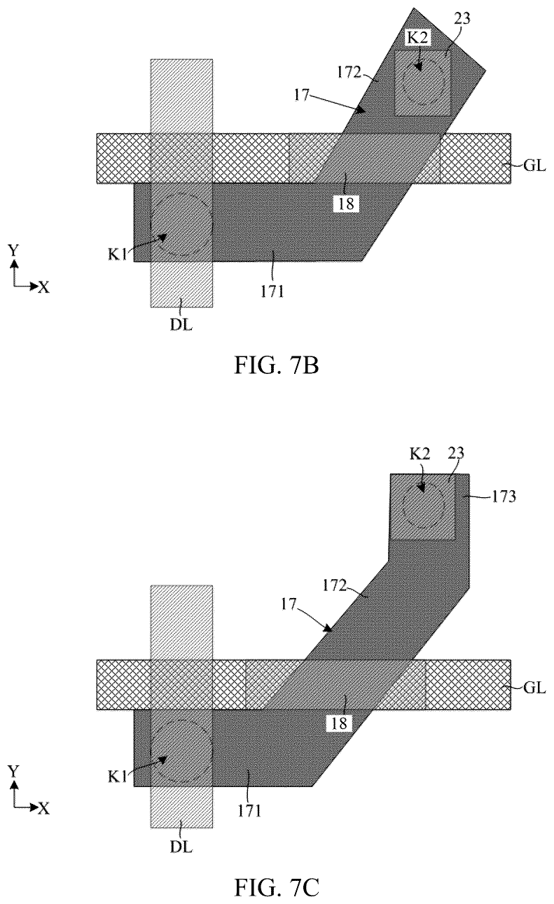

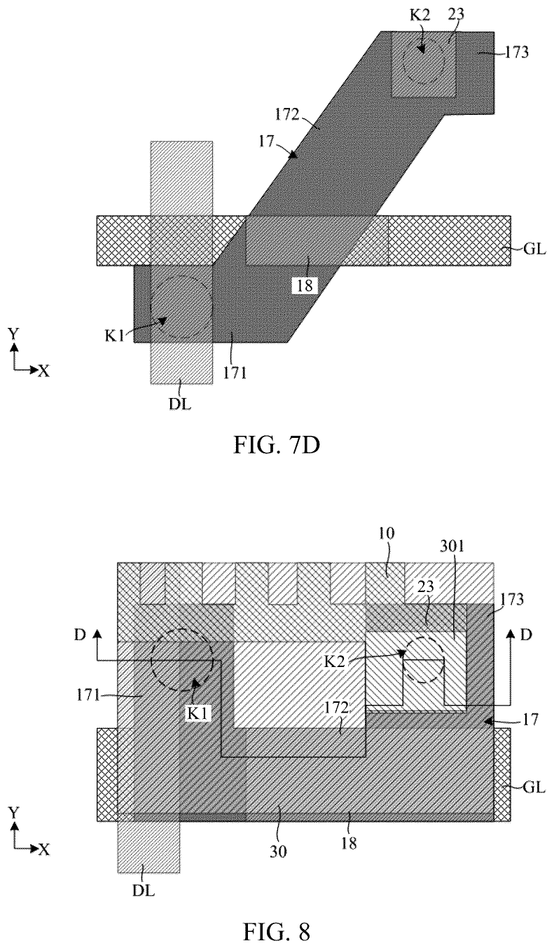

FIG. 7A is a first schematic partial top view of a display region of an array substrate according to yet another embodiment of the present disclosure. As shown in FIG. 7A, FIG. 7A is a schematic partial top view after a second conductive layer is formed in a display region of an array substrate. As shown in FIG. 7A, a gate line GL may be a line shape extending in a first direction X, and a data line DL may be a line shape extending in a second direction Y. An orthographic projection of the data line DL on the array substrate may include an orthographic projection of a first opening K1 on the array substrate.

As shown in FIG. 7A, a first active part 17 may include a first section 171 and a second section 172 which are connected with each other. The first section 171 extends in the first direction X. A first end of the second section 172 is connected to an end of the first section 171, and a second end of the second section 172 extends in the second direction Y. A first zone and a first channel zone of the first active part 17 may both be located in the first section 171, and a second zone of the first active part 17 may be located in the second section 172.

As shown in FIG. 7A, an orthographic projection of the second conductive part 18 on the array substrate may be a rectangle, and the orthographic projection of the second conductive part 18 on the array substrate may at least partially overlap with the orthographic projection of the first section 171 on the array substrate.

As shown in FIG. 7A, an orthographic projection of a pixel connection electrode 23 on the array substrate may be a rectangle. The orthographic projection of the pixel connection electrode 23 on the array substrate may be located within an orthographic projection of the second section 172 on the array substrate, and the orthographic projection of the pixel connection electrode 23 on the array substrate may include an orthographic projection of a second opening K2 on the array substrate.

FIG. 7B is a second schematic partial top view of a display region of an array substrate according to yet another embodiment of the present disclosure. As shown in FIG. 7B, FIG. 7B is a schematic partial top view after a second conductive layer is formed in a display region of an array substrate. As shown in FIG. 7B, a gate line GL may be a line shape extending in a first direction X, and a data line DL may be a line shape extending in a second direction Y. An orthographic projection of the data line DL on the array substrate may include an orthographic projection of a first opening K1 on the array substrate.

As shown in FIG. 7B, a first active part 17 may include a first section 171 and a second section 172 which are connected with each other. The first section 171 extends in the first direction X. A first end of the second section 172 is connected to an end of the first section 171, and a second end of the second section 172 may extend in a direction different from the first direction X and the second direction Y. For example, the second end of the second section 172 may extend in a diagonal direction of the first direction X and the second direction Y. A first zone of the first active part 17 may be located in the first section 171, and a second zone of the first active part 17 may be located in the second section 172. A portion of a first channel zone of the first active part 17 may be located in the first section 171, and other portions of the first channel zone of the first active part 17 may be located in the second section 172.

As shown in FIG. 7B, an orthographic projection of the second conductive part 18 on the array substrate may be a rectangle, and the orthographic projection of the second conductive part 18 on the array substrate may at least partially overlap with orthographic projections of the first section 171 and the second section 172 on the array substrate.

As shown in FIG. 7B, an orthographic projection of a pixel connection electrode 23 on the array substrate may be a rectangle. The orthographic projection of the pixel connection electrode 23 on the array substrate may be within an orthographic projection of the second section 172 on the array substrate, and the orthographic projection of the pixel connection electrode 23 on the array substrate may include an orthographic projection of a second opening K2 on the array substrate.

FIG. 7C is a third schematic partial top view of a display region of an array substrate according to yet another embodiment of the present disclosure. As shown in FIG. 7C, FIG. 7C is a schematic partial top view after a second conductive layer is formed in the display region of the array substrate. As shown in FIG. 7C, a gate line GL may be a line shape extending in a first direction X, and a data line DL may be a line shape extending in a second direction Y. An orthographic projection of the data line DL on the array substrate may include an orthographic projection of a first opening K1 on the array substrate.

As shown in FIG. 7C, a first active part 17 may include a first section 171, a second section 172, and a third section 173 which are connected with each other. A first end of the first section 171 may be connected to a first end of the second section 172, and a second end of the first section 171 may extend in an opposite direction of the first direction X. A second end of the second section 172 may extend in a direction different from the first direction X and the second direction Y. For example, the second end of the second section 172 may extend in a diagonal direction of the first direction X and the second direction Y. A first end of the third section 173 may be connected to the second end of the second section 172, and a second end of the third section 173 may extend in the second direction Y. A first zone of the first active part 17 may be located in the first section 171. A portion of a first channel zone of the first active part 17 may be located in the first section 171, and other portions of the first channel zone of the first active part 17 may be located in the second section 172. A second zone of the first active part 17 may be located in the third section 173.

As shown in FIG. 7C, an orthographic projection of the second conductive part 18 on the array substrate may be a rectangle, and the orthographic projection of the second conductive part 18 on the array substrate may at least partially overlap with orthographic projections of the first section 171 and the second section 172 on the array substrate.

As shown in FIG. 7C, an orthographic projection of a pixel connection electrode 23 on the array substrate may be a rectangle. The orthographic projection of the pixel connection electrode 23 on the array substrate may be located within an orthographic projection of the third section 173 on the array substrate, and the orthographic projection of the pixel connection electrode 23 on the array substrate may include an orthographic projection of a second opening K2 on the array substrate.

FIG. 7D is a fourth schematic partial top view of a display region of an array substrate according to yet another embodiment of the present disclosure. As shown in FIG. 7D, FIG. 7D is a schematic partial top view after a second conductive layer is formed in the display region of the array substrate. As shown in FIG. 7D, a gate line GL may be a line shape extending in a first direction X, and a data line DL may be a line shape extending in a second direction Y. An orthographic projection of the data line DL on the array substrate may include an orthographic projection of a first opening K1 on the array substrate.

As shown in FIG. 7D, a first active part 17 may include a first section 171, a second section 172, and a third section 173 which are connected with each other. A first end of the first section 171 may be connected to a first end of the second section 172, and a second end of the first section 171 may extend in an opposite direction of the first direction X. The second end of the second section 172 may extend in a direction different from the first direction X and the second direction Y. For example, the second end of the second section 172 may extend in a diagonal direction of the first direction X and the second direction Y. A first end of the third section 173 may be connected to the second end of the second section 172, and a second end of the third section 173 may extend in the first direction X. A first zone of the first active part 17 may be located in the first section 171. A portion of a first channel zone of the first active part 17 may be located in the first section 171, and other portions of the first channel zone of the first active part 17 may be located in the second section 172. A second zone of the first active part 17 may be located in the third section 173.

As shown in FIG. 7D, an orthographic projection of the second conductive part 18 on the array substrate may be a rectangle, and the orthographic projection of the second conductive part 18 on the array substrate may at least partially overlap with orthographic projections of the first section 171 and the second section 172 on the array substrate.

As shown in FIG. 7D, an orthographic projection of a pixel connection electrode 23 on the array substrate may be a rectangle. The orthographic projection of the pixel connection electrode 23 on the array substrate may be located within an orthographic projection of the third section 173 on the array substrate, and the orthographic projection of the pixel connection electrode 23 on the array substrate may include an orthographic projection of a second opening K2 on the array substrate.

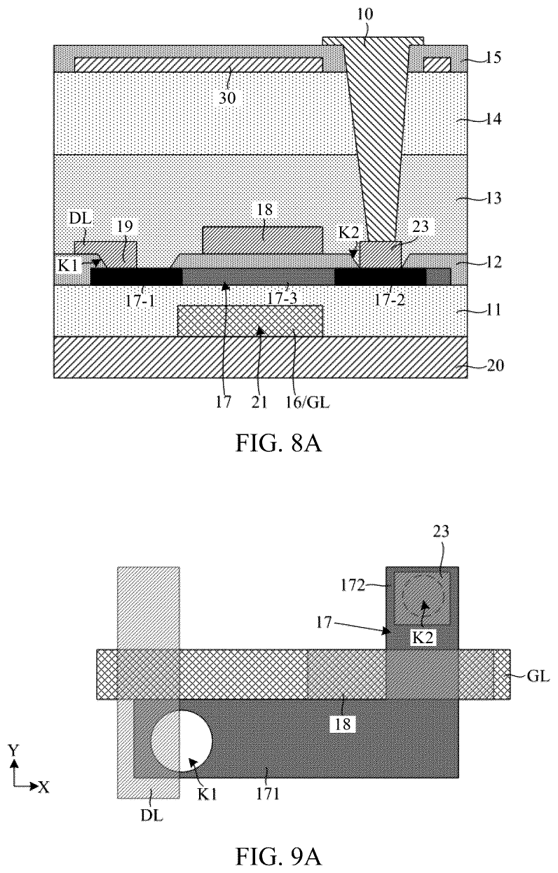

FIG. 8 is a schematic partial top view of a display region of an array substrate according to a further embodiment of the present disclosure. FIG. 8A is a schematic partial cross-sectional view of a display region of an array substrate according to a further embodiment of the present disclosure, and FIG. 8A is a schematic cross-sectional view at an identified D-D in FIG. 8. As shown in FIGS. 8 and 8A, the display region of the array substrate may include a base substrate 20 and a first conductive layer, a semiconductor layer, a second conductive layer, a third conductive layer, and a fourth conductive layer disposed on a side of the base substrate 20. The display region of the array substrate may also include a first insulating layer 11 located between the first conductive layer and the semiconductor layer, a second insulating layer 12 located between the semiconductor layer and the second conductive layer, a third insulating layer 13 and a fourth insulating layer 14 located between the second conductive layer and the third conductive layer, and a fifth insulating layer 15 located between the third conductive layer and the fourth conductive layer.

The first conductive layer may include a first conductive part 16 of a first transistor 21 and a gate line GL. The semiconductor layer may include a first active part 17 of the first transistor 21. The second conductive layer may include a data line DL, a fifth conductive part 19, a second conductive part 18, and a pixel connection electrode 23. The data line DL is electrically connected to a first electrode of the first transistor 21 via the fifth conductive part 19. The fifth conductive part 19 and the data line DL may be interconnected to form an integral structure. The third conductive layer may include a common electrode 30, and the fourth conductive layer may include a pixel electrode 10 electrically connected to a second electrode of the first transistor 21 via the pixel connection electrode 23. The common electrode 30 has a hollow region 301 via which the pixel electrode 10 may be electrically connected to the second electrode of the first transistor 21. In an embodiment of the present disclosure, by arranging the data line DL on a side of the first transistor away from the base substrate 20, a size of an opening provided in the second insulating layer 12 can be reduced. The data line DL is electrically connected to the first electrode of the first transistor 21 via the opening, and the fifth conductive part 19 can be located within the opening, so that an area of the opening region of the array substrate can be increased, and an aperture ratio of the array substrate can be increased.

In an exemplary embodiment, as shown in FIG. 8A, the fifth conductive part 19 may be electrically connected to the data line DL and a first zone 17-1 via a first opening K1 located in the second insulating layer 12. The pixel electrode 10 may be electrically connected to a second zone 17-2 via the pixel connection electrode 23, and at least a portion of the pixel connection electrode 23 may be located within a second opening K2 of the second insulating layer 12. An orthographic projection of the fifth conductive part 19 on the array substrate is within an orthographic projection of the first opening K1 on the array substrate, and the orthographic projection of the fifth conductive part 19 on the array substrate is smaller than the orthographic projection of the first opening K1 on the array substrate. The fifth conductive part 19 and the data line DL may be interconnected to form an integral structure. An orthographic projection of the data line DL on the array substrate may include the orthographic projection of the fifth conductive part 19 on the array substrate, so that an occupation of the fifth conductive part 19 on an area of the opening region of the array substrate can be reduced, and the aperture ratio of the array substrate can be increased.

In an exemplary embodiment, as shown in FIG. 8, the gate line GL may be a line shape extending in a first direction X, and the data line DL may be a line shape extending in a second direction Y. An orthographic projection of the data line DL on the array substrate partially overlaps with an orthographic projection of the first opening K1 on the array substrate.

As shown in FIG. 8, the first active part 17 may include a first section 171, a second section 172, and a third section 173 which are connected with each other. A first end of the first section 171 may be connected to a first end of the second section 172, and a second end of the first section 171 may extend in the second direction Y. A second end of the second section 172 may extend in the first direction X. A first end of the third section 173 may be connected to the second end of the second section 172, and a second end of the third section 173 may extend in the second direction Y. A first zone of the first active part 17 may be located in the first section 171. A first channel zone of the first active part 17 may be located in the second section 172, and a second zone of the first active part 17 may be located in the third section 173.

As shown in FIG. 8, an orthographic projection of the second conductive part 18 on the array substrate may be a rectangle. The orthographic projection of the second conductive part 18 on the array substrate may at least partial overlap with an orthographic projection of the second section 172 on the array substrate.

As shown in FIG. 8, an orthographic projection of the pixel connection electrode 23 on the array substrate may be a rectangle. The orthographic projection of the pixel connection electrode 23 on the array substrate may be located within an orthographic projection of the third section 173 on the array substrate, and the orthographic projection of the pixel connection electrode 23 on the array substrate includes an orthographic projection of the second opening K2 on the array substrate.

In some exemplary embodiments, the first opening K1 may be a circular opening, a rectangular opening, an elliptical opening, a hexagonal opening, or the like.

In some exemplary embodiments, the second opening K2 may be a circular opening, a rectangular opening, an elliptical opening, a hexagonal opening, or the like.

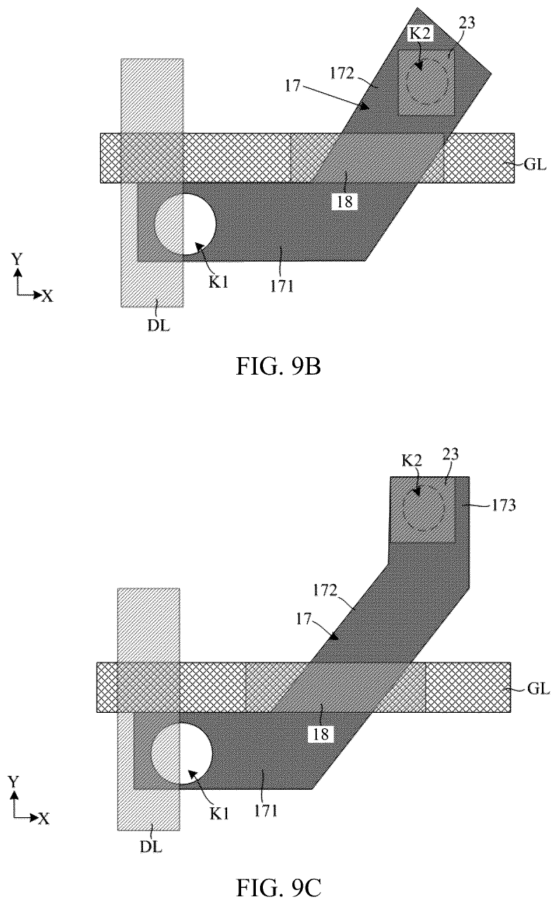

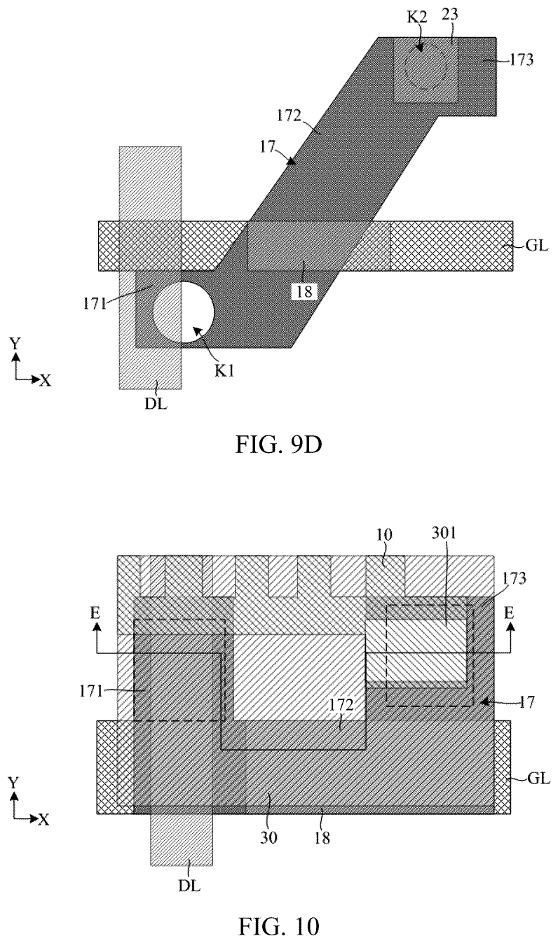

FIG. 9A is a first schematic partial top view of a display region of an array substrate according to yet another embodiment of the present disclosure. As shown in FIG. 9A, FIG. 9A is a schematic partial top view after a second conductive layer is formed in a display region of an array substrate. As shown in FIG. 9A, a gate line GL may be a line shape extending in a first direction X, and a data line DL may be a line shape extending in a second direction Y. An orthographic projection of the data line DL on the array substrate partially overlaps with an orthographic projection of a first opening K1 on the array substrate.

As shown in FIG. 9A, a first active part 17 may include a first section 171 and a second section 172 which are connected with each other. The first section 171 extends in the first direction X. A first end of the second section 172 is connected to an end of the first section 171, and a second end of the second section 172 extends in the second direction Y. A first zone and a first channel zone of the first active part 17 may both be located in the first section 171, and a second zone of the first active part 17 may be located in the second section 172.

As shown in FIG. 9A, an orthographic projection of a pixel connection electrode 23 on the array substrate may be a rectangle. The orthographic projection of the pixel connection electrode 23 on the array substrate may be located within an orthographic projection of the second section 172 on the array substrate, and the orthographic projection of the pixel connection electrode 23 on the array substrate includes an orthographic projection of a second opening K2 on the array substrate.

FIG. 9B is a second schematic partial top view of a display region of an array substrate according to yet another embodiment of the present disclosure. As shown in FIG. 9B, FIG. 9B is a schematic partial top view after a second conductive layer is formed in a display region of an array substrate. As shown in FIG. 9B, a gate line GL may be a line shape extending in a first direction X, and a data line DL may be a line shape extending in a second direction Y. An orthographic projection of the data line DL on the array substrate partially overlaps with an orthographic projection of a first opening K1 on the array substrate.

As shown in FIG. 9B, a first active part 17 may include a first section 171 and a second section 172 which are connected with each other. The first section 171 extends in the first direction X. A first end of the second section 172 is connected to an end of the first section 171, and a second end of the second section 172 may extend in a direction different from the first direction X and the second direction Y. For example, the second end of the second section 172 may extend in a diagonal direction of the first direction X and the second direction Y. A first zone of the first active part 17 may be located in the first section 171, and a second zone of the first active part 17 may be located in the second section 172. A portion of a first channel zone of the first active part 17 may be located in the first section 171, and other portions of the first channel zone of the first active part 17 may be located in the second section 172.

As shown in FIG. 9B, an orthographic projection of a pixel connection electrode 23 on the array substrate may be a rectangle. The orthographic projection of the pixel connection electrode 23 on the array substrate may be located within an orthographic projection of the second section 172 on the array substrate, and the orthographic projection of the pixel connection electrode 23 on the array substrate includes an orthographic projection of a second opening K2 on the array substrate.

FIG. 9C is a third schematic partial top view of a display region of an array substrate according to yet another embodiment of the present disclosure. As shown in FIG. 9C, FIG. 9C is a schematic partial top view after a second conductive layer is formed in the display region of the array substrate. As shown in FIG. 9C, a gate line GL may be a line shape extending in a first direction X, and a data line DL may be a line shape extending in a second direction Y. An orthographic projection of the data line DL on the array substrate partially overlaps with an orthographic projection of a first opening K1 on the array substrate.

As shown in FIG. 9C, the first active part 17 may include a first section 171, a second section 172, and a third section 173 which are connected with each other. A first end of the first section 171 may be connected to a first end of the second section 172, and a second end of the first section 171 may extend in an opposite direction of the first direction X. A second end of the second section 172 may extend in a direction different from the first direction X and the second direction Y. For example, the second end of the second section 172 may extend in a diagonal direction of the first direction X and the second direction Y. A first end of the third section 173 may be connected to the second end of the second section 172, and a second end of the third section 173 may extend in the second direction Y. A first zone of the first active part 17 may be located in the first section 171. A portion of a first channel zone of the first active part 17 may be located in the first section 171, and other portions of the first channel zone of the first active part 17 may be located in the second section 172. A second zone of the first active part 17 may be located in the third section 173.

As shown in FIG. 9C, an orthographic projection of a pixel connection electrode 23 on the array substrate may be a rectangle. The orthographic projection of the pixel connection electrode 23 on the array substrate may be located within an orthographic projection of the third section 173 on the array substrate, and the orthographic projection of the pixel connection electrode 23 on the array substrate may include an orthographic projection of a second opening K2 on the array substrate.

FIG. 9D is a fourth schematic partial top view of a display region of an array substrate according to another embodiment of the present disclosure. As shown in FIG. 9D, FIG. 9D is a schematic partial top view after a second conductive layer is formed in the display region of the array substrate. As shown in FIG. 9D, a gate line GL may be a line shape extending in a first direction X, and a data line DL may be a line shape extending in a second direction Y. An orthographic projection of the data line DL on the array substrate partially overlaps with an orthographic projection of a first opening K1 on the array substrate.

As shown in FIG. 9D, a first active part 17 may include a first section 171, a second section 172, and a third section 173 which are connected with each other. A first end of the first section 171 may be connected to a first end of the second section 172, and a second end of the first section 171 may extend in an opposite direction of the first direction X. The second end of the second section 172 may extend in a direction different from the first direction X and the second direction Y. For example, the second end of the second section 172 may extend in a diagonal direction of the first direction X and the second direction Y. A first end of the third section 173 may be connected to the second end of the second section 172, and a second end of the third section 173 may extend in the first direction X. A first zone of the first active part 17 may be located in the first section 171. A portion of a first channel zone of the first active part 17 may be located in the first section 171, and other portions of the first channel zone of the first active part 17 may be located in the second section 172. A second zone of the first active part 17 may be located in the third section 173.

As shown in FIG. 9D, an orthographic projection of a pixel connection electrode 23 on the array substrate may be a rectangle. At least a portion of the orthographic projection of the pixel connection electrode 23 on the array substrate may be located within an orthographic projection of the third section 173 on the array substrate, and the orthographic projection of the pixel connection electrode 23 on the array substrate includes an orthographic projection of a second opening K2 on the array substrate.

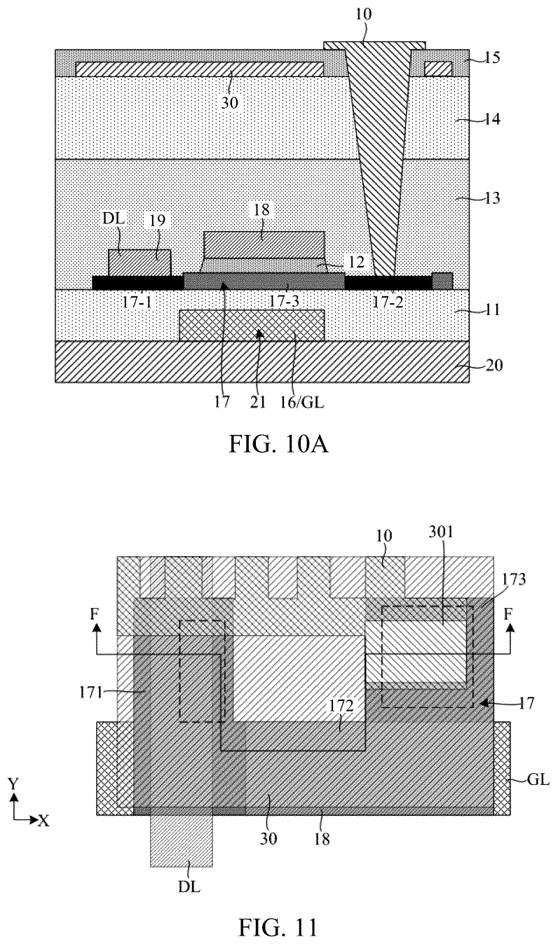

FIG. 10 is a schematic partial top view of a display region of an array substrate according to an exemplary embodiment of the present disclosure. FIG. 10A is a schematic partial cross-sectional view of a display region of an array substrate according to an exemplary embodiment of the present disclosure, and FIG. 10A is a schematic cross-sectional view at an identified E-E in FIG. 10. As shown in FIGS. 10 and 10A, an orthographic projection of a second conductive part 18 on the array substrate is located within an orthographic projection of a second insulating layer 12 on the array substrate. In a process of preparing a pattern of a second conductive layer, a second etching can be performed on the second insulating layer 12 to improve uniformity of the etching. Due to the second etching on the second insulating layer 12, a portion of a first active part 17 is thinned. In FIG. 10, two rectangular dashed boxes illustrate a region where the first active part 17 is partially thinned.

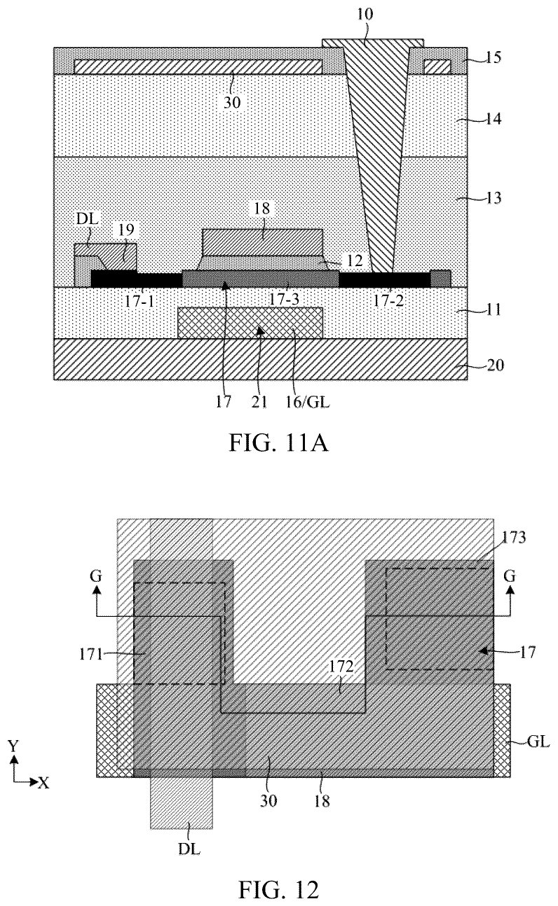

FIG. 11 is a schematic partial top view of a display region of an array substrate according to another exemplary embodiment of the present disclosure, and FIG. 11A is a schematic partial cross-sectional view of a display region of an array substrate according to another exemplary embodiment of the present disclosure. FIG. 11A is a schematic cross-sectional view at an identified F-F in FIG. 11. As shown in FIGS. 11 and 11A, an orthographic projection of a second conductive part 18 on the array substrate is located within an orthographic projection of a second insulating layer 12 on the array substrate, and an orthographic projection of a data line DL on the array substrate includes other portions of the orthographic projection of the second insulating layer 12 on the array substrate. In a process of preparing a pattern of a second conductive layer, a second etching can be performed on the second insulating layer 12 to improve uniformity of the etching. Due to the second etching on the second insulating layer 12, a portion of a first active part 17 is thinned. In FIG. 11, two rectangular dashed boxes illustrate a region where the first active part 17 is partially thinned.

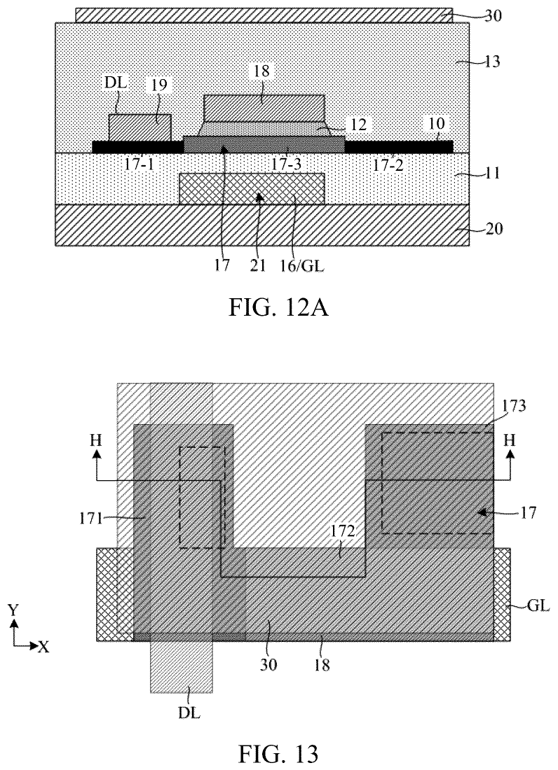

FIG. 12 is a schematic partial top view of a display region of an array substrate according to yet another exemplary embodiment of the present disclosure, and FIG. 12A is a schematic partial cross-sectional view of a display region of an array substrate according to yet another exemplary embodiment of the present disclosure. FIG. 12A is a schematic cross-sectional view at an identified G-G in FIG. 12. As shown in FIGS. 12 and 12A, the display region of the array substrate may include a base substrate 20 and a first conductive layer, a semiconductor layer, a second conductive layer, and a third conductive layer disposed on a side of the base substrate 20. The display region of the array substrate may also include a first insulating layer 11 located between the first conductive layer and the semiconductor layer, a second insulating layer 12 located between the semiconductor layer and the second conductive layer, and a third insulating layer 13 located between the second conductive layer and the third conductive layer. The first conductive layer may include a first conductive part 16 of a first transistor 21 and a gate line GL. The semiconductor layer may include a first active part 17 of the first transistor 21. The second conductive layer may include a data line DL, a fifth conductive part 19, and a second conductive part 18. The data line DL is electrically connected to a first electrode of the first transistor 21 via the fifth conductive part 19. The fifth conductive part 19 and the data line DL may be interconnected to form an integral structure. The third conductive layer may include a common electrode 30. A pixel electrode 10 and the first active part 17 can be interconnected to form an integral structure, so that the number of film layers of the array substrate can be reduced, the preparation process of the array substrate is simplified, and damage to the active layer caused by etching openings on the insulating layer can be avoided.

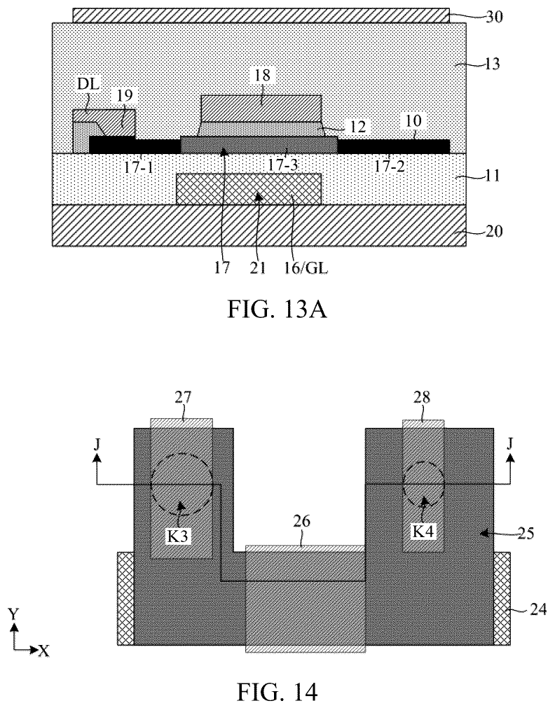

FIG. 13 is a schematic partial top view of a display region of an array substrate according to yet another exemplary embodiment of the present disclosure, and FIG. 13A is a schematic partial cross-sectional view of a display region of an array substrate according to yet another exemplary embodiment of the present disclosure. FIG. 13A is a schematic cross-sectional view at an identified H-H in FIG. 13. As shown in FIGS. 13 and 13A, an orthographic projection of a second conductive part 18 on the array substrate is located within an orthographic projection of a second insulating layer 12 on the array substrate, and an orthographic projection of a data line DL on the array substrate includes other portions of the orthographic projection of the second insulating layer 12 on the array substrate. In a process of preparing a pattern of a second conductive layer, a second etching can be performed on the second insulating layer 12 to improve uniformity of the etching. Due to the second etching on the second insulating layer 12, a portion of a first active part 17 is thinned. In FIG. 13, two rectangular dashed boxes illustrate a region where the first active part 17 is partially thinned.

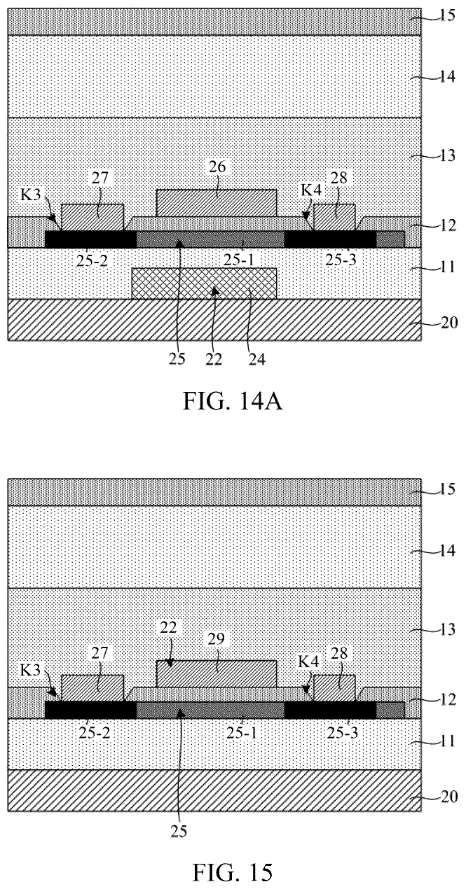

FIG. 14 is a schematic partial top view of a non-display region of an array substrate according to an embodiment of the present disclosure. FIG. 14A is a schematic partial cross-sectional view of a non-display region of an array substrate according to an embodiment of the present disclosure, and FIG. 14A is a schematic cross-sectional view at an identified J-J in FIG. 14. As shown in FIGS. 14 and 14A, the non-display region of the array substrate may include a base substrate 20 and a first conductive layer, a semiconductor layer, and a second conductive layer disposed on a side of the base substrate 20. The non-display region of the array substrate may also include a first insulating layer 11 located between the first conductive layer and the semiconductor layer, a second insulating layer 12 located between the semiconductor layer and the second conductive layer, and a third insulating layer 13, a fourth insulating layer 14, and a fifth insulating layer 15 located sequentially on a side of the second conductive layer away from the base substrate 20. The first conductive layer may include a fourth conductive part 24 of a second transistor 22. The semiconductor layer may include a second active part 25 of the second transistor 22. The second conductive layer may include a third conductive part 26 of the second transistor 22. An orthographic projection of the fourth conductive part 24 on the array substrate, an orthographic projection of the second active part 25 on the array substrate, and an orthographic projection of the third conductive part 26 on the array substrate may all overlap at least partially. The third conductive part 26 may be a second gate of the second transistor. The fourth conductive part 24 may be a light shielding layer of the second transistor.

In an exemplary embodiment, as shown in FIG. 14A, the second active part 25 may include a second channel zone 25-1, and a third zone 25-2 and a fourth zone 25-3 located on two opposite sides of the second channel zone 25-1. For example, in a process of preparing the array substrate, a conductorization processing may be performed on portions of the second active part 25, so that the portions of the second active part 25 form the third zone 25-2 and the fourth zone 25-3, respectively. The third zone 25-2 of the second active part 25 may be used as a first electrode of the second transistor, and the fourth zone 25-3 of the second active part 25 may be used as a second electrode of the second transistor 22. A conductorization process of the semiconductor layer is not limited in embodiments of the present disclosure.

In an exemplary embodiment, as shown in FIG. 14A, the second conductive layer may also include a first connection electrode 27 and a second connection electrode 28. For example, the second transistor 22 may be electrically connected to the data line via the first connection electrode 27. The first connection electrode 27 may be electrically connected to the third zone 25-2 of the second active part 25 via a third opening K3 located in the second insulating layer 12. An orthographic projection of the first connection electrode 27 on the array substrate may at least partially overlap with an orthographic projection of the third opening K3 on the array substrate. The second connection electrode 28 may be electrically connected to a fourth zone 25-3 of the second active part 25 via a fourth opening K4 located in the second insulating layer 12. An orthographic projection of the second connection electrode 28 on the array substrate may at least partially overlap with an orthographic projection of the fourth opening K4 on the array substrate.

In an exemplary embodiment, the voltages applied by the second conductive part and the fourth conductive part are the same or different.

FIG. 15 is a schematic partial cross-sectional view of a non-display region of an array substrate according to another embodiment of the present disclosure. As shown in FIG. 15, the non-display region of the array substrate may include a base substrate 20 and a semiconductor layer and a second conductive layer disposed on a side of the base substrate 20. The non-display region of the array substrate may also include a first insulating layer 11 located between the base substrate 20 and the semiconductor layer, a second insulating layer 12 located between the semiconductor layer and the second conductive layer, and a third insulating layer 13, a fourth insulating layer 14, and a fifth insulating layer 15 located sequentially on the side of the second conductive layer away from the base substrate 20. The semiconductor layer may include a second active part 25 of a second transistor 22. The second active part 25 may include a second channel zone 25-1, a third zone 25-2 and a fourth zone 25-3 located on opposite sides of the second channel zone 25-1. The second conductive layer may include a second gate 29, a first connection electrode 27, and a second connection electrode 28 of the second transistor 22. For example, the second transistor 22 may be electrically connected to the data line via the first connection electrode 27. The first connection electrode 27 may be electrically connected to the third zone 25-2 of the second active part 25 via a third opening K3 located in the second insulating layer 12. The second connection electrode 28 may be electrically connected to a fourth zone 25-3 of the second active part 25 via a fourth opening K4 located in the second insulating layer 12.

A structure of an array substrate is described below by an example of a manufacturing process of the array substrate. A “patterning process” mentioned in the embodiments of the present disclosure includes a treatment such as photoresist coating, mask exposure, development, etching, and photoresist stripping for a metal material, an inorganic material, or a transparent conductive material, and includes a treatment such as organic material coating, mask exposure, and development for an organic material. Deposition may be any one or more of sputtering, evaporation, and chemical vapor deposition, coating may be any one or more of spray coating, spin coating, and inkjet printing, and etching may be any one or more of dry etching and wet etching, the present disclosure is not limited thereto. A “thin film” refers to a layer of thin film made of a material on a base substrate by using deposition, coating, or another process. If the “thin film” does not need to be processed through a patterning process in the entire manufacturing process, the “thin film” may also be called a “layer”. If the “thin film” needs to be processed through the patterning process in the entire manufacturing process, the “thin film” is called a “thin film” before the patterning process is performed and is called a “layer” after the patterning process is performed. At least one “pattern” is contained in the “layer” which has been processed through the patterning process. In the present disclosure, “A and B are of a same layer structure” means that A and B are formed through a same one-time patterning process.

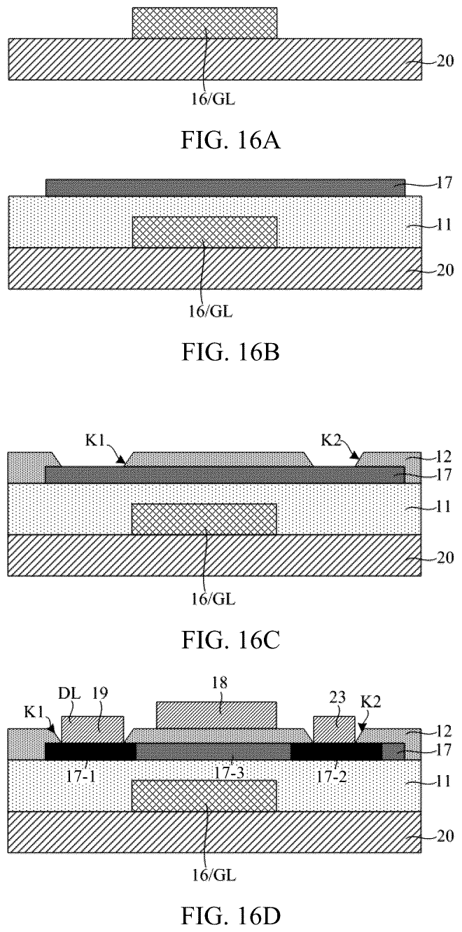

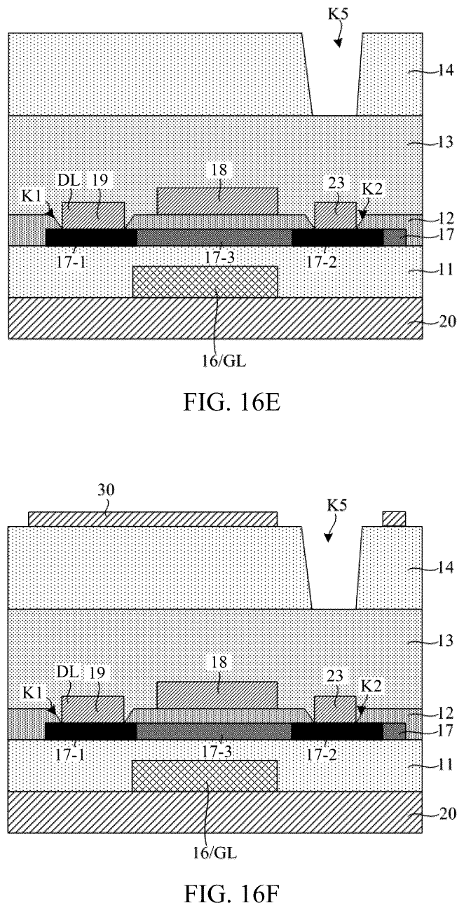

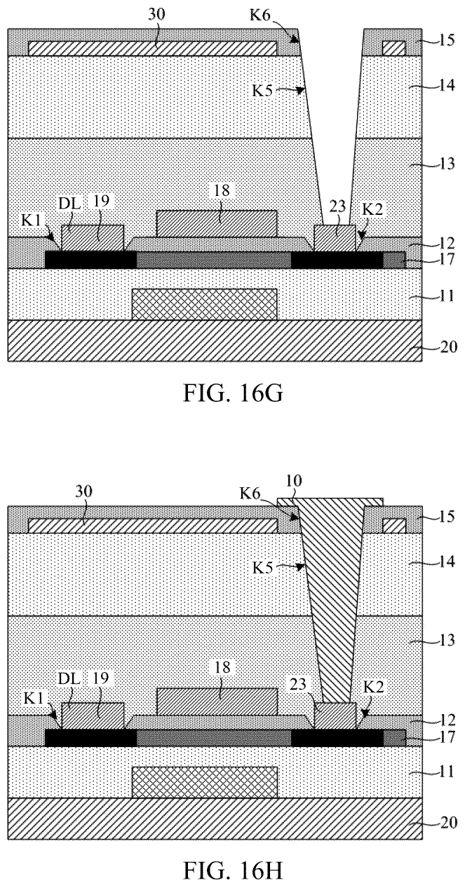

FIGS. 16A to 16H are schematic diagrams of a preparation process of a display region of an array substrate according to an embodiment of the present disclosure. The preparation process for the array substrate may include the following steps.

(11) Forming a pattern of a first conductive layer. Forming the pattern of the first conductive layer may include depositing a first conductive thin film on a side of a base substrate 20, and patterning the first conductive thin film by a patterning process, to form a pattern of the first conductive layer on a side of the base substrate 20. The first conductive layer may include a gate line GL and a first conductive part 16 of a first transistor, as shown in FIG. 16A.

In some exemplary embodiments, a thickness of the first conductive layer may range from 1000 angstroms to 10000 angstroms.

(12) Forming a pattern of a semiconductor layer. Forming the pattern of the semiconductor layer may include sequentially depositing a first insulating thin film and a semiconductor thin film on a side of the base substrate 20 on which the aforementioned pattern is formed, and patterning the semiconductor thin film by a patterning process to form a first insulating layer 11 on a side of the first conductive layer away from the base substrate 20, and a pattern of the semiconductor layer on a side of the first insulating layer 11 away from the base substrate 20. The semiconductor layer may include a first active part 17 of the first transistor, as shown in FIG. 16B.

In some exemplary embodiments, a thickness of the first insulating layer 11 may range from 100 nanometers to 700 nanometers.

In some exemplary embodiments, a thickness of the semiconductor layer may range from 10 nanometers to 80 nanometers.

(13) Forming a pattern of a second insulating layer. Forming the pattern of the second insulating layer may include depositing a second insulating thin film on a side of the base substrate 20 on which the aforementioned patterns are formed, and patterning the second insulating thin film by a patterning process to form a second insulating layer 12 on a side of the semiconductor layer away from the base substrate 20, as shown in FIG. 16C. The second insulating layer 12 is provided with at least one first opening K1 and at least one second opening K2. The at least one first opening K1 and the at least one second opening K2 both penetrate the second insulating layer 12 and expose a portion of a surface of the first active part 17. The first opening K1 is configured such that a fifth conductive part formed subsequently is located within the opening, and the second opening K2 is configured such that at least a portion of a pixel connection electrode formed subsequently is located within the opening.

In some exemplary embodiments, a thickness of the second insulating layer may range from 600 angstroms to 2000 angstroms.

(14) Forming a pattern of a second conductive layer. Forming the pattern of the second conductive layer may include depositing a second conductive thin film on a side of the base substrate 20 on which the aforementioned patterns are formed, and patterning the second conductive thin film by a patterning process to form a pattern of the second conductive layer on a side of the second insulating layer 12 away from the base substrate 20. The second conductive layer may include a data line DL, a fifth conductive part 19, a second conductive part 18, and a pixel connection electrode 23, as shown in FIG. 16D.

Forming the pattern of the second conductive layer may also include performing a conductorization processing on portions of the first active part 17. The conductorization processing may be performed on the portions of the first active part 17, so that the portions of the first active part 17 form a first zone 17-1 and a second zone 17-2, respectively. The first zone 17-1 of the first active part 17 may be used as a first electrode of the first transistor, and the second zone 17-2 of the first active part 17 may be used as a second electrode of the first transistor. A conductorization process of the semiconductor layer is not limited in embodiments of the present disclosure. The first active part 17 may also include a first channel zone 17-3 located between the first zone 17-1 and the second zone 17-2.

As shown in FIG. 16D, the data line DL and the fifth conductive part 19 may be interconnected to form an integral structure. The fifth conductive part 19 is located within the first opening K1 and is electrically connected to the first zone 17-1 of the first active part 17. An orthographic projection of the data line DL on the array substrate may include an orthographic projection of the fifth conductive part 19 on the array substrate, so that a size of the first opening K1 may be reduced and an aperture ratio of the array substrate may be increased.

As shown in FIG. 16D, at least a portion of the pixel connection electrode 23 is located within the second opening K2 and is electrically connected to the second zone 17-2 of the first active part 17, and the pixel connection electrode 23 is configured to be electrically connected to a pixel electrode formed subsequently.

In some exemplary embodiments, the thickness of the second conductive layer may range from 200 nanometers to 1200 nanometers.

(15) Forming a pattern of a fourth insulating layer. Forming the pattern of the fourth insulating layer may include sequentially depositing a third insulating thin film and a fourth insulating thin film on a side of the base substrate 20 on which the aforementioned patterns are formed and patterning the fourth insulating thin film by a patterning process to form a third insulating layer 13 and a fourth insulating layer 14 on a side of the second conductive layer away from the base substrate 20, as shown in FIG. 16E.

As shown in FIG. 16E, the fourth insulating layer 14 includes at least one fifth opening K5 that penetrates the fourth insulating layer and exposes a portion of a surface of the third insulating layer away from the base substrate 20. An orthographic projection of the fifth opening K5 on the array substrate at least partially overlaps with an orthographic projection of the pixel connection electrode 23 on the array substrate. The fifth opening K5 is configured such that the pixel electrode formed subsequently is electrically connected to the pixel connection electrode 23 via the opening, so as to realize the electric connection of the pixel electrode to the second zone 17-2 of the first active part 17.

As shown in FIG. 16E, the orthographic projection of the fifth opening K5 on the array substrate may include the orthographic projection of the pixel connection electrode 23 on the array substrate, thereby improving the reliability of the electrical connection between the pixel electrode and the pixel connection electrode 23 formed subsequently.

In some exemplary embodiments, a thickness of the third insulating layer 13 may range from 200 nanometers to 400 nanometers.

In some exemplary embodiments, a thickness of the fourth insulating layer 14 may range from 2.0 microns to 3.0 microns.

(16) Forming a pattern of a third conductive layer. Forming the pattern of the third conductive layer may include depositing a third conductive thin film on a side of the base substrate 20, and patterning the third conductive thin film by a patterning process to form the pattern of the third conductive layer located on a side of the fourth insulating layer 14 away from the base substrate 20. The third conductive layer may include a common electrode 30, as shown in FIG. 16F.

In some exemplary embodiments, a thickness of the third conductive layer may range from 400 angstroms to 1000 angstroms.

(17) Forming a pattern of a fifth insulating layer. Forming the pattern of the fifth insulating layer may include depositing a fifth insulating thin film on a side of the base substrate 20 on which the aforementioned patterns are formed, and patterning the fifth insulating thin film by a patterning process to form a fifth insulating layer 15 on a side of the third conductive layer away from the base substrate 20, as shown in FIG. 16G.

As shown in FIG. 16G, the fifth insulating layer 15 may include at least one sixth opening K6, and both the fifth insulating layer 15 and the third insulating layer 13 located within the sixth opening K6 are etched off, and a portion of a surface of the pixel connection electrode 23 away from the base substrate 20 is exposed. An orthographic projection of the sixth opening K6 on the array substrate includes an orthographic projection of the fifth opening K5 on the array substrate, so that the difficulty of etching the sixth opening K6 can be reduced, and the time for preparing the sixth opening K6 can be shortened.

The sixth opening K6 is configured such that the pixel electrode formed subsequently is electrically connected to the pixel connection electrode 23 via the opening.

In some exemplary embodiments, a thickness of the fifth insulating layer 15 may range from 1000 angstroms to 3000 angstroms.

(18) Forming a pattern of a fourth conductive layer. Forming the pattern of the fourth conductive layer may include depositing a fourth conductive thin film on a side of the base substrate 20 on which the aforementioned patterns are formed, and patterning the fourth conductive thin film by a patterning process to form the pattern of the fourth conductive layer on a side of the fifth insulating layer 15 away from the base substrate 20. The fourth conductive layer may include a pixel electrode 10, as shown in FIG. 16H. The pixel electrode 10 is electrically connected to the pixel connection electrode 23 via the sixth opening K6.

In some exemplary embodiments, a thickness of the fourth conductive layer may range from 40 nanometers to 135 nanometers.

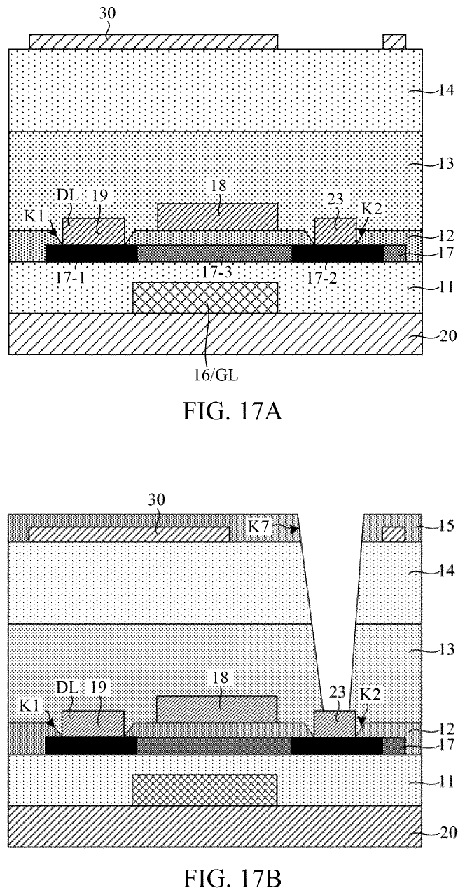

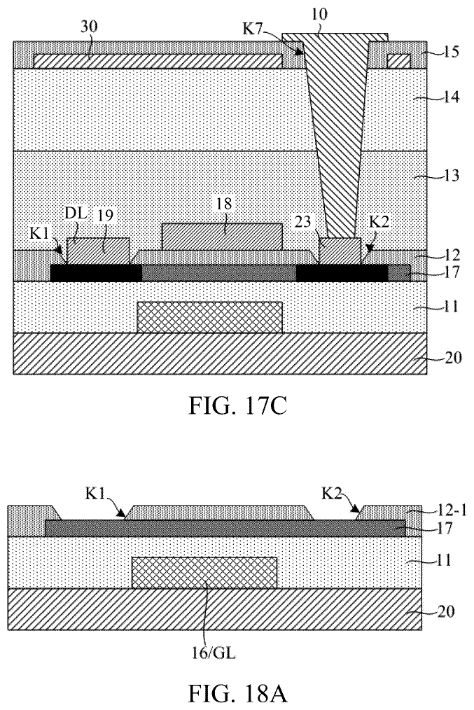

FIGS. 17A to 17C are schematic diagrams of a preparation process of a display region of an array substrate according to another embodiment of the present disclosure. The preparation process for the array substrate may include the following steps.

(21) Successively forming a pattern of a first conductive layer, a pattern of a semiconductor layer, a pattern of a second insulating layer, and a pattern of a second conductive layer, which can be referenced from the above-described embodiments.

(22) Forming a pattern of a third conductive layer. Forming the pattern of the third conductive layer may include sequentially depositing a third insulating thin film, a fourth insulating thin film, and a third conductive thin film on a side of the base substrate 20 on which the aforementioned patterns are formed, and patterning the third conductive thin film by a patterning process to sequentially form a third insulating layer 13, a fourth insulating layer 14, and a pattern of the third conductive layer on a side of the second conductive layer away from the base substrate 20. The third conductive layer may include a common electrode 30, as shown in FIG. 17A.

(23) Forming a pattern of a fifth insulating layer. Forming the pattern of the fifth insulating layer may include depositing a fifth insulating thin film on a side of the base substrate 20 on which the aforementioned patterns are formed, and patterning the fifth insulating thin film by a patterning process to form a fifth insulating layer 15 on a side of the third conductive layer away from the base substrate 20, as shown in FIG. 17B.

As shown in FIG. 17B, the fifth insulating layer 15 may include at least one seventh opening K7, and the fifth insulating layer 15, the fourth insulating layer 14, and the third insulating layer 13 located within the seventh opening K7 are all etched off, and a portion of a surface of the pixel connection electrode 23 away from the base substrate 20 is exposed. The seventh opening K7 is configured such that a pixel electrode formed subsequently is electrically connected to the pixel connection electrode 23 via the opening.

(24) Forming a pattern of a fourth conductive layer. Forming the pattern of the fourth conductive layer may include depositing a fourth conductive thin film on a side of the base substrate 20 on which the aforementioned patterns are formed, and patterning the fourth conductive thin film by a patterning process, to form the pattern of the fourth conductive layer on a side of the fifth insulating layer 15 away from the base substrate 20. The fourth conductive layer may include a pixel electrode 10, as shown in FIG. 17C. The pixel electrode 10 is electrically connected to the pixel connection electrode 23 via the seventh opening K7.

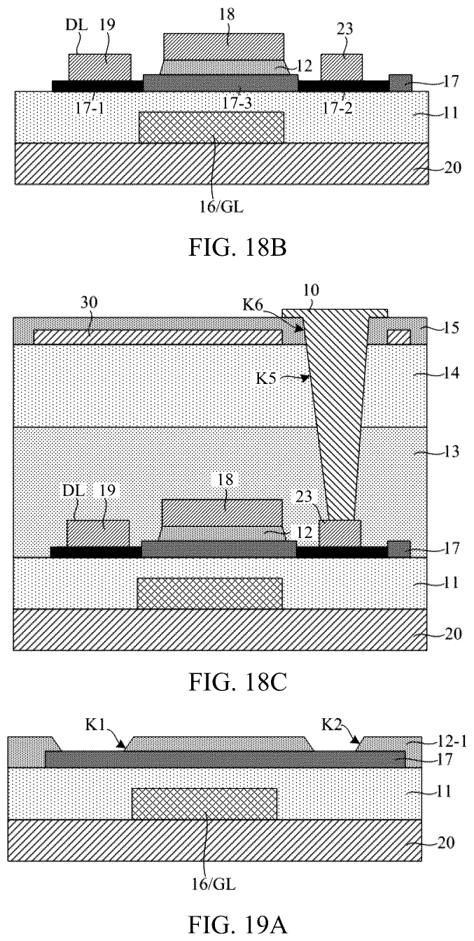

FIGS. 18A to 18C are schematic diagrams of a preparation process of a display region of an array substrate according to yet another embodiment of the present disclosure. The preparation process for the array substrate may include the following steps.

(31) Sequentially forming a pattern of a first conductive layer and a pattern of a semiconductor layer, which can be referenced from the aforementioned embodiments and will not be elaborated.

(32) Forming an initial pattern of a second insulating layer. Forming an initial pattern 12-1 of a second insulating layer may include: depositing a second insulating thin film on a side of the base substrate 20 on which the aforementioned patterns are formed, and patterning the second insulating thin film by a patterning process to form the initial pattern 12-1 of the second insulating layer on a side of the semiconductor layer away from the base substrate 20, as shown in FIG. 18A. The initial pattern 12-1 of the second insulating layer is provided with at least one first opening K1 and at least one second opening K2. The at least one first opening K1 and the at least one second opening K2 both penetrate the second insulating thin film and expose portions of a surface of a first active part 17. The first opening K1 is configured such that a fifth conductive part formed subsequently is located within the opening, and the second opening K2 is configured such that at least a portion of a pixel connection electrode formed subsequently is located within the opening.

(33) Forming a pattern of a second conductive layer. Forming the pattern of the second conductive layer may include depositing a second conductive thin film on a side of the base substrate 20 on which the aforementioned patterns are formed, and patterning the second conductive thin film by a patterning process, to form the pattern of the second conductive layer on a side of the initial pattern of the second insulating layer away from the base substrate 20. The second conductive layer may include a data line DL, a fifth conductive part 19, a second conductive part 18, and a pixel connection electrode 23, as shown in FIG. 18B.

Forming the pattern of the second conductive layer may also include performing a conductorization processing on portions of the first active part 17. The conductorization processing may be performed on portions of the first active part 17, so that the portions of the first active part 17 form a first zone 17-1 and a second zone 17-2, respectively. The first zone 17-1 of the first active part 17 may be used as a first electrode of the first transistor, and the second zone 17-2 of the first active part 17 may be used as a second electrode of the first transistor.

Forming the pattern of the second conductive layer may also include patterning the initial pattern of the second insulating layer to form the second insulating layer 12, as shown in FIG. 18B.

(34) Sequentially forming a third insulating layer 13, a fourth insulating layer 14, a third conductive layer, a fifth insulating layer 15, and a fourth conductive layer, as shown in FIG. 18C, which can be referenced from the aforementioned embodiments and will not be elaborated.

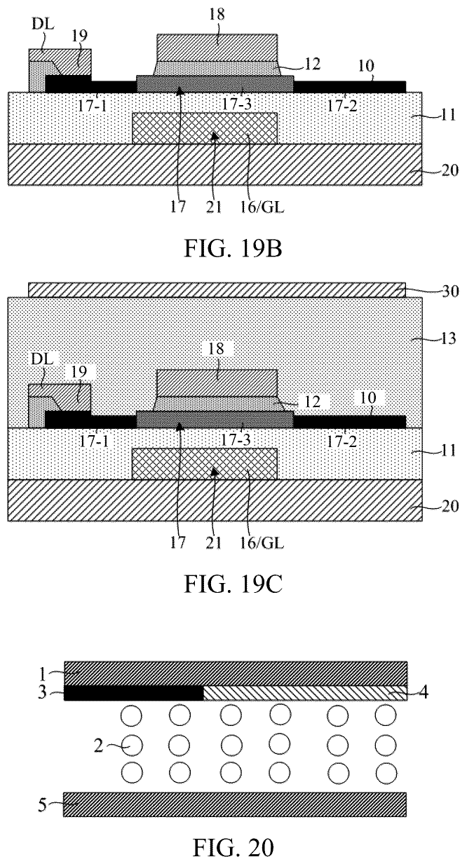

FIGS. 19A to 19C are schematic diagrams of a preparation process of a display region of an array substrate according to yet another embodiment of the present disclosure. The preparation process for the array substrate may include the following steps.

(41) Sequentially forming a pattern of a first conductive layer and a pattern of a semiconductor layer, which can be referenced from the aforementioned embodiments and will not be elaborated.

(42) Forming an initial pattern of a second insulating layer. Forming the initial pattern 12-1 of the second insulating layer may include: depositing a second insulating thin film on a side of the base substrate 20 on which the aforementioned patterns are formed, and patterning the second insulating thin film by a patterning process, to form an initial pattern 12-1 of the second insulating layer on a side of the semiconductor layer away from the base substrate 20, as shown in FIG. 19A. The initial pattern 12-1 of the second insulating layer is provided with at least one first opening K1 and at least one second opening K2. The at least one first opening K1 and the at least one second opening K2 both penetrate the second insulating thin film and expose portions of a surface of a first active part 17. The first opening K1 is configured such that a fifth conductive part formed subsequently is located within the opening.

(43) Forming a pattern of a second conductive layer. Forming the pattern of the second conductive layer may include depositing a second conductive thin film on a side of the base substrate 20 on which the aforementioned patterns are formed, and patterning the second conductive thin film by a patterning process to form a pattern of the second conductive layer on a side of the initial pattern of the second insulating layer away from the base substrate 20. The second conductive layer may include a data line DL, a fifth conductive part 19, and a second conductive part 18, as shown in FIG. 19B.

Forming the pattern of the second conductive layer may also include performing a conductorization processing on portions of the first active part 17. The conductorization processing may be performed on portions of the first active part 17, so that the portions of the first active part 17 form a first zone 17-1 and a second zone 17-2, respectively. The first zone 17-1 of the first active part 17 may be used as a first electrode of the first transistor, and the second zone 17-2 of the first active part 17 may be used as a second electrode of the first transistor.

Forming the pattern of the second conductive layer may also include patterning the initial pattern of the second insulating layer to form a second insulating layer 12, as shown in FIG. 19B.

As shown in FIG. 19B, the pixel electrode 10 and the first active part 17 may be interconnected to form an integral structure, so that a film layer structure of the array substrate may be simplified, the need to provide an opening for realizing an electrical connection of the pixel electrodes is eliminated, and damage to the first active part caused by an etching operation is avoided.

(44) Sequentially forming a third insulating layer 13 and a third conductive layer, as shown in FIG. 19C, which can be referenced from the aforementioned embodiments and will not be elaborated.

FIG. 20 is a schematic cross-sectional view of a display apparatus according to an embodiment of the present disclosure. As shown in FIG. 20, an embodiment of the present disclosure further provides a display apparatus. For example, the display apparatus can implement the ADS (Advanced Super Dimension Switch) mode. The display apparatus may include an array substrate 5 which may be the array substrate provided by any of the preceding embodiments.

The display apparatus may further include an opposing substrate 1 and a liquid crystal layer 2 disposed between the array substrate 5 and the opposing substrate 1. The pixel electrode and the common electrode included in the array substrate 5 may be configured to generate an electric field that controls deflection of liquid crystal molecules in the liquid crystal layer 2. As shown in FIG. 20, the liquid crystal molecules in the liquid crystal layer 2 may be arranged horizontally on the array substrate 5, and in an embodiment of the present disclosure, a horizontal direction is parallel to a plane where the array substrate 5 is located.

In an exemplary embodiment, as shown in FIG. 20, the opposing substrate 1 may include an underlay substrate, and a black matrix 3 and a color film layer 4 disposed on the underlay substrate. However, the embodiments of the present disclosure are not limited to this.

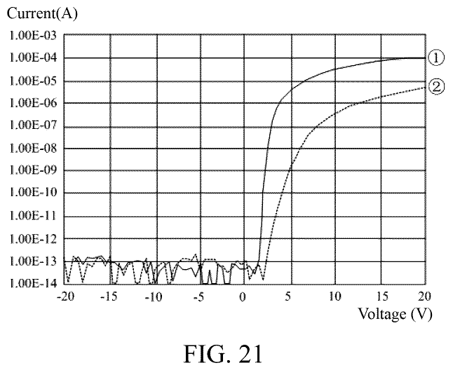

FIG. 21 is a characteristic test simulation graph of the first transistor. As shown in FIG. 21, curve \textcircled{1} shows that the first gate of the first transistor is farther away from the base substrate than the data line, and curve \textcircled{2} shows that the first transistor adopts the first transistor structure provided in any of the above embodiments of the present disclosure. As can be seen from FIG. 21, adopting the first transistor structure provided by an embodiment of the present disclosure makes it easier to adjust the transistor to a forward threshold voltage, and is advantageous to improve a sand phenomenon in the display region.

An embodiment of the present disclosure further provides a display apparatus. The display apparatus includes the array substrate described in any one of the foregoing embodiments. The display apparatus may be any product or component with a display function such as liquid crystal panel, electronic paper, a mobile phone, a tablet computer, a television, a display, a notebook computer, a digital photo frame, a navigator. However, this is not limited in the embodiments of the present disclosure.

Although the embodiments disclosed in the present disclosure are described as above, the described contents are only embodiments which are adopted in order to facilitate understanding of the present disclosure, and are not intended to limit the present disclosure. It should be noted that the above examples or embodiments are exemplary only and not restrictive. Therefore, the present disclosure is not limited to what is specifically shown and described herein. Various modifications, substitutions or omissions may be made in forms and details of implementation modes without departing from the scope of the present disclosure.

1. An array substrate comprising a base substrate comprising a display region and a non-display region surrounding the display region; wherein the display region comprises at least one first transistor, the first transistor comprising a first active part, a first conductive part and a second conductive part; the non-display region comprises at least one second transistor, the second transistor comprising a second active part, a third conductive part and a fourth conductive part; and both the first active part and the second active part are located in a semiconductor layer, and the first conductive part and the third conductive part are located in different conductive layers; and
in a plane perpendicular to the array substrate, the second conductive part and the fourth conductive part are respectively located on both opposite sides of the semiconductor layer; and
the second conductive part is in a floating state.

2. The array substrate according to claim 1, wherein the non-display region comprises a gate drive circuit configured to be electrically connected to a gate line of the display region, and the gate drive circuit comprises the at least one second transistor.

3. The array substrate according to claim 1, wherein the non-display region comprises at least one of an electrostatic discharge circuit, a test circuit, and a demultiplexer circuit; and the electrostatic discharge circuit, the test circuit, and the demultiplexer circuit all comprise the at least one second transistor.

4. The array substrate according to claim 1, wherein the first conductive part is a gate of the first transistor, the second conductive part and the first conductive part are respectively located on both opposite sides of the first active part, and an orthographic projection of the second conductive part on a plane where the base substrate is located at least partially overlaps with an orthographic projection of the first active part on the plane where the base substrate is located;
the third conductive part is a gate of the second transistor, the fourth conductive part and the third conductive part are respectively located on both opposite sides of the second active part, and an orthographic projection of the fourth conductive part on the plane where the base substrate is located at least partially overlaps with an orthographic projection of the second active part on the plane where the base substrate is located; and
wherein voltages applied by the second conductive part and the fourth conductive part are the same or different.

5. The array substrate according to claim 4, wherein the fourth conductive part is electrically connected to the first conductive part, and voltages applied by the fourth conductive part and the first conductive part are the same.

6. The array substrate according to claim 4, wherein a voltage of the second conductive part is lower than a voltage of the first conductive part.

7. An array substrate comprising a base substrate, the base substrate comprising a display region and a non-display region surrounding the display region; wherein the display region comprises at least one first transistor, the first transistor comprising a first conductive part, a first active part, a second conductive part and a fifth conductive part; the second conductive part and the fifth conductive part are arranged on a same layer; the second conductive part is located on a side of the first conductive part away from the base substrate; and the second conductive part is in a floating state.

8. The array substrate according to claim 7, wherein an absolute value of a difference between a value of a voltage applied by the second conductive part and a value of a voltage applied by the fifth conductive part is greater than an absolute value of a difference between the value of the voltage applied by the second conductive part and a value of a voltage applied by the first conductive part.

9. The array substrate according to claim 7, wherein the display region further comprises at least one data line, the at least one data line being arranged on the same layer as the second conductive part.

10. The array substrate according to claim 9, wherein the at least one data line is electrically connected to the at least one first transistor via the fifth conductive part; and an orthographic projection of the at least one data line on a plane where the base substrate is located comprises an orthographic projection of the fifth conductive part on the plane where the base substrate is located.

11. The array substrate according to claim 10, wherein the display region further comprises a gate insulating layer, and the gate insulating layer is located on a side of the first active part away from the base substrate; and the gate insulating layer comprises at least one first opening, and the fifth conductive part is located within the at least one first opening.

12. The array substrate according to claim 11, wherein an orthographic projection of the at least one data line on the plane where the base substrate is located at least partially overlaps with an orthographic projection of the at least one first opening on the plane where the base substrate is located.

13. The array substrate according to claim 12, wherein the orthographic projection of the at least one data line on the plane where the base substrate is located comprises the orthographic projection of the at least one first opening on the plane where the base substrate is located.

14. The array substrate according to claim 11, wherein the at least one first opening exposes a part of a surface of the first active part away from the base substrate, and the fifth conductive part is in contact with a part of a surface of the first active part away from the base substrate.

15. The array substrate according to claim 11, wherein the display region further comprises at least one common electrode and at least one pixel electrode, and both the at least one common electrode and the at least one pixel electrode are located on a side of the gate insulating layer away from the base substrate, and an orthographic projection of the at least one common electrode on the plane where the base substrate is located at least partially overlaps with an orthographic projection of the at least one pixel electrode on the plane where the base substrate is located; and
the gate insulating layer further comprises at least one second opening, and the at least one pixel electrode is electrically connected to the at least one first transistor via the at least one second opening.

16. The array substrate according to claim 15, wherein the display region further comprises at least one gate line, and the at least one gate line is arranged on the same layer as the first conductive part; the first active part comprises a first section, a second section and a third section which are connected with each other; a first end of the first section is connected to a first end of the second section, and a second end of the first section extends in a second direction; a second end of the second section extends in a first direction, and a first end of the third section is connected to the second end of the second section, and a second end of the third section extends in the second direction; and the first direction intersects the second direction; and
wherein an orthographic projection of the at least one first opening on the plane where the base substrate is located is within an orthographic projection of the first section on the plane where the base substrate is located, an orthographic projection of the at least one second opening on the plane where the base substrate is located is within an orthographic projection of the third section on the plane where the base substrate is located, and the at least one first opening and the at least one second opening are located on the same side of the gate line.

17. The array substrate according to claim 15, wherein the display region further comprises at least one gate line, and the at least one gate line is arranged on the same layer as the first conductive part; the first active part comprises a first section and a second section which are connected with each other; the first section extends in a first direction, a first end of the second section is connected to an end of the first section, and a second end of the second section extends in a second direction; and the first direction intersects the second direction; and
wherein an orthogonal projection of the at least one first opening on the plane where the base substrate is located is within an orthogonal projection of the first section on the plane where the base substrate is located, an orthogonal projection of the at least one second opening on the plane where the base substrate is located is within an orthogonal projection of the second section on the plane where the base substrate is located, and the at least one first opening and the at least one second opening are located on both sides of the gate line.

18. The array substrate according to claim 15, wherein the display region further comprises at least one gate line, and the at least one gate line is arranged on the same layer as the first conductive part; the first active part comprises a first section and a second section which are connected with each other; the first section extends in a first direction, a first end of the second section is connected to an end of the first section, and a second end of the second section extends in a third direction, the first direction is perpendicular to a second direction, and the third direction is different from both the first direction and the second direction; and
wherein an orthogonal projection of the at least one first opening on the plane where the base substrate is located is within an orthogonal projection of the first section on the plane where the base substrate is located, an orthogonal projection of the at least one second opening on the plane where the base substrate is located is within an orthogonal projection of the second section on the plane where the base substrate is located, and the at least one first opening and the at least one second opening are located on both sides of the gate line.

19. The array substrate according to claim 15, wherein the display region further comprises at least one gate line, and the at least one gate line is arranged on the same layer as the first conductive part; the first active part comprises a first section, a second section and a third section which are connected with each other; a first end of the first section is connected to a first end of the second section, a second end of the first section extends in an opposite direction of a first direction, a second end of the second section extends in a third direction, the first direction is perpendicular to a second direction, and the third direction is different from both the first direction and the second direction; a first end of the third section is connected to the second end of the second section, and a second end of the third section extends in the second direction; and
wherein an orthographic projection of the at least one first opening on the plane where the base substrate is located is within an orthographic projection of the first section on the plane where the base substrate is located; an orthographic projection of the at least one second opening in the plane where the base substrate is located is within an orthographic projection of the third section in the plane where the base substrate is located, and the at least one first opening and the at least one second opening are located on both sides of the gate line.

20. A display apparatus comprising the array substrate according to claim 1, an opposing substrate, and a liquid crystal layer; wherein the array substrate is disposed opposite to the opposing substrate, and the liquid crystal layer is located between the array substrate and the opposing substrate.
